(19) United States
(12) Patent Application Publication
(10) Pub. No.: US 2025/0247454 A1
(43) Pub. Date: Jul. 31, 2025

(54) BEHAVIORAL ANALYTICS PLATFORM WITH ENHANCED BEHAVIORAL ANALYSIS AND CLASSIFICATION WITH MOBILE DATA COLLECTION

(71) Applicant: Makor Analytics, Inc., Millburn, NJ (US)

(72) Inventors: Esther J. Bliner, Livingston, NJ (US); James Hodson, El Cerrito, CA (US)

(21) Appl. No.: 18/621,024

(22) Filed: Mar. 28, 2024

Related U.S. Application Data
(63) Continuation-in-part of application No. 18/422,697, filed on Jan. 25, 2024.

(51) Int. Cl. H04L 67/50

(52) U.S. Cl. CPC H04L 67/535; G06F 11/3438; G06F 16/337; G06Q 30/0203; H04L 67/142

(57) ABSTRACT

A behavioral analysis platform is a comprehensive system designed to enhance the accuracy of polls and surveys. It utilizes a online survey optimized through payload management and employs machine and deep learning models to analyze behavioral, haptic, or biometric data. The platform captures user behavior, including mouse movements, response times, and other haptic data, using custom APIs. It features a payload manager subsystem for campaign planning and execution, optimizing survey elements for behavioral analytics. The system establishes a behavioral baseline for each respondent, enabling precise analysis of survey responses in terms of conviction, veracity, and sentiment. Real-time adjustments to survey elements and continuous data capture contribute to improved predictive capabilities.

### CROSS-REFERENCE TO RELATED APPLICATIONS

Priority is claimed in the application data sheet to the following patents or patent applications, each of which is expressly incorporated herein by reference in its entirety:
Ser. No. 18/422,697

### BACKGROUND OF THE INVENTION

### Field of the Art

The present invention is in the field of data collection, and more particularly in the field of form or survey behavioral data collection.

### Discussion of the State of the Art

The approach to surveys has barely evolved in over a century: the only information that is collected in standard surveys or polls around the world is self-reported data (i.e., the final answers provided by survey/poll respondents). There are several significant known limitations of self-reported data which include lack of standardization in responses, untruthful responses, and implicit biases. The limitations and inaccuracies of self-reported data were highlighted repeatedly during the 2016 and 2020 United States of America presidential election polls, which missed the mark on the election results.

In order to improve the accuracy of polls and surveys and to remediate the limitations of self-reported data, it is necessary to measure and analyze behavioral data from surveys, polls, forms, or the like, in order to capture the end-to-end user journey of how respondents arrived at their answers, thereby capturing the decision-making process behind each answer.

What is needed is a behavioral analytics platform which overcomes these limitations and which provides a system and method enhanced behavioral survey data capture and analysis.

### SUMMARY OF THE INVENTION

Accordingly, the inventor has conceived and reduced to practice, a behavioral analytics platform with enhanced behavioral analysis and classification with mobile data collection, which is a comprehensive system designed to enhance the accuracy of any respondent-based data collection methodology. It utilizes a digitally-served survey, prompt, or task that employs machine and deep learning models to analyze behavioral data. The platform captures user behavior, including mouse movements, response times, page engagement, and other haptic data, using custom APIs. It may utilize a payload manager subsystem for campaign planning and execution, optimizing survey elements for behavioral analytics. The system establishes a behavioral baseline for each respondent, enabling precise analysis of survey responses in terms of a respondent's emotional state including but not limited to conviction, veracity, and sentiment, anger, or trust. Real-time adjustments to survey elements and continuous data capture contribute to improved predictive capabilities. The platform is universally applicable and is capable of monitoring and processing survey results dynamically. Overall, it offers a sophisticated approach to behavioral analysis for more accurately capturing end-user beliefs. This, in turn, enables granular audience segmentation and group analysis based on behavioral insights, augmenting self-reported data.

According to a preferred embodiment, a platform for enhanced behavioral analysis and classification with mobile data collection processing, and analysis, comprising: a plurality of computing devices each comprising at least a processor, a memory, and a network interface; wherein a plurality of programming instructions stored in one or more of the memories and operating on one or more processors of the plurality of computing devices causes the plurality of computing devices to: collect a plurality of behavioral, haptic, or biometric data, the plurality of behavioral, haptic, or biometric data from a plurality of behavioral, haptic, or biometric sensors; process the plurality of behavioral, haptic, or biometric data through a behavioral model to generate a model result, and; assess a behavioral or cognitive state of the respondent based on the model result, is disclosed.

According to another preferred embodiment, a method for enhanced behavioral analysis and classification with mobile data collection processing, and analysis, comprising the steps of: collecting a plurality of behavioral, haptic, or biometric data, the plurality of behavioral, haptic, or biometric data from a plurality of behavioral, haptic, or biometric sensors; parsing the behavioral, haptic, or biometric data to identify a first dataset associated with one or more baseline questions and a second dataset associated with one or more non-baseline questions; processing the plurality of behavioral, haptic, or biometric data through a behavioral model to generate a model result, and; assessing a behavioral or cognitive state of the respondent based on the model result, is disclosed.

According to an aspect of an embodiment, the behavioral model generates a behavioral baseline by processing a subset of the plurality of behavioral, haptic, or biometric data associated with a plurality of baseline or questions.

According to an aspect of an embodiment, the behavioral model makes predictions about the respondent's behavioral and cognitive state based on comparisons between the plurality of behavioral, haptic, or biometric data and the model result

According to an aspect of an embodiment, the data collection form is a survey, poll, or structured form.

According to an aspect of an embodiment, the plurality of behavioral, haptic, or biometric sensors are built into a mobile computing device.

According to an aspect of an embodiment, the behavioral, haptic, or biometric data is gathered by a mobile phone, watch, wristband, headband, sensor, or similar electronic device.

According to an aspect of an embodiment, the behavioral data comprises trajectory data, the trajectory data comprising mouse or finger trajectory data, directional changes, and micro-movement data.

According to an aspect of an embodiment, the behavioral data comprises timing data, the timing data comprising response time, dwell time, hover time, and transition time.

According to an aspect of an embodiment, the behavioral data comprises data received from any digital channel.

According to an aspect of an embodiment, the behavioral data comprises keystroke pattern data.

According to an aspect of an embodiment, the behavioral data comprises one or more changes of answer.

According to an aspect of an embodiment, the respondent's physical and cognitive state includes mental and emotional state such as but not limited to conviction, veracity, and sentiment, anger, or trust.

### BRIEF DESCRIPTION OF THE DRAWING FIGURES

FIG. 1 is a block diagram illustrating an exemplary system architecture for a behavioral analysis platform with adaptive baselining, according to an embodiment.

FIG. 2 is a block diagram illustrating an exemplary aspect of a behavioral analysis platform with adaptive baselining, a payload manager subsystem.

FIG. 3 is a block diagram illustrating an exemplary aspect of behavioral analysis platform with adaptive baselining, a behavioral analysis subsystem.

FIG. 4A is block diagram illustrating exemplary data capture of an answer event on a user device 400, according to an embodiment.

FIG. 4B is a diagram illustrating a n-dimensional hypercube comprising the decomposed behavioral data associated with the respondent's answer event of FIG. 4A, according to an embodiment.

FIG. 5 is a block diagram illustrating exemplary data capture of an answer event on a user device, according to an embodiment.

FIG. 6A is a diagram illustrating an exemplary multiple-choice survey, poll, or form payload format that may be implemented in some embodiments and the capture of behavioral data associated thereof.

FIG. 6B illustrates an exemplary answer event for the multiple-choice question, according to an embodiment.

FIG. 7 is a diagram illustrating an exemplary slider question survey, poll, or form payload format that may be implemented in some embodiments and the capture of behavioral data associated thereof.

FIG. 8 is a diagram illustrating an exemplary open-ended question survey, poll, or form payload format that may be implemented in some embodiments and the capture of behavioral data associated thereof.

FIG. 9 shows an exemplary behavioral model result produced by one or more trained behavioral models based on received behavioral data, according to the embodiment.

FIG. 10 is a flow diagram illustrating an exemplary method for training a behavioral model to make behavioral predictions, according to an embodiment.

FIG. 11 is a flow diagram illustrating an exemplary method for performing collecting and analyzing behavioral survey data, according to an embodiment.

FIG. 12 is a block diagram illustrating an exemplary system architecture for a behavioral analysis platform with adaptive baselining utilizing a data acquisition subsystem, according to an embodiment.

FIG. 13 is a block diagram illustrating an exemplary system architecture for a behavioral analysis platform with adaptive baselining utilizing a baseline analysis subsystem and a group analysis subsystem, according to an embodiment.

FIG. 14 is a flow diagram illustrating an exemplary method for updating and grouping baseline “fingerprints.”

FIG. 15 illustrates an exemplary computing environment on which an embodiment described herein may be implemented.

FIG. 16 is a block diagram illustrating exemplary data capture of an answer event on a user device where the answer event has been gamified, according to an embodiment.

FIG. 17 is a flow diagram illustrating an exemplary method for the mobile collection and analysis of behavioral, haptic, and biometric data, according to an embodiment.

FIG. 18 illustrates an exemplary computing environment on which an embodiment described herein may be implemented.

### DETAILED DESCRIPTION OF THE INVENTION

The inventor has conceived, and reduced to practice, a behavioral analytics platform with enhanced behavioral analysis and classification with mobile data collection which is a comprehensive system designed to enhance the accuracy of polls and surveys. It utilizes a online survey optimized through payload management and employs machine and deep learning models to analyze behavioral data. The platform captures user behavior, including mouse movements, response times, and other haptic data, using custom APIs. It features a payload manager subsystem for campaign planning and execution, optimizing survey elements for behavioral analytics. The system establishes a behavioral baseline for each respondent, enabling precise analysis of survey responses in terms of emotional state in areas such as but not limited to conviction, veracity, and sentiment. In some embodiments, it may not be necessary to baseline each respondent depending on the goal of a particular survey, poll, task, or assessment. For example, if a field sobriety test is being conducted or a similarly situated medical assessment, baselining an individual may not be necessary. In some embodiments, the system only baseline an individual when necessary to achieve the goal of survey, poll, task, or assessment. Behavioral baselines may also be calculated for a distribution of users over a series of baseline questions, for a specific subset of users, or for users in a selected peer group. Real-time adjustments to survey elements and continuous data capture contribute to improved predictive capabilities. The platform is applicable across various media types and is capable of monitoring and processing survey results dynamically. Overall, it offers a sophisticated approach to behavioral analysis for more accurately capturing end-user authentic sentiment. By incorporating data collected through a plurality of digital channels, the behavioral analysis platform may also make additional assessments including but not limited to medical, risk, and financial assessments.

According to an embodiment, a behavioral analysis platform can be configured to improve the accuracy of polls and surveys by first optimizing the payload of an online or offline survey, poll, or any other form to enhance the effectiveness of capturing a plurality of behavioral data associated with a respondent to the survey, poll, or form, and then by using one or more trained machine and/or deep learning models to analyze the behavioral data. The platform can provide a more precise and nuanced understanding of what respondents truly think and feel, not only what they say (i.e., the final survey answers).

According to an embodiment, a behavioral analysis platform can be configured to improve the accuracy of financial, medical, and risk assessments. Data collects from a plurality of digital channels may further augments the behavioral analysis platform, resulting in even more accurate assessments. The behavioral analysis platform may be configured to conduct any analysis where a plurality of respondent data is used in the analysis.

According to one aspect, the platform may be directed to message resonance testing. The platform can provide a means for evaluating the effectiveness and resonance of messages, irrespective of industry. Some examples include marketing messaging testing of any kind (e.g., for goods or services, movies/commercials or any other media), A/B testing, evaluation of effectiveness of programs. Message testing can be applied to provide predictive insights into the effectiveness of any program designed to change ideas, thoughts, or behaviors. For example, the platform could be leveraged to assess whether various programs are working as intended, authentic sentiment about consumer savings program, weight loss program, or any other lifestyle program.

According to one aspect, the platform may be directed to application assessment and selection. Because the platform can characterize cognitive states such as but not limited to conviction and veracity using various behavioral models, the platform could assist humans in an enterprise triage the selection process of any application process. For example, for U.S. Visa applications the platform could help U.S. evaluators prioritize who should be scrutinized more carefully based on their behavioral markers. For insurance underwriters of any kind such as health care or property underwriters, the platform could provide a “veracity score” to help them determine who has been honest on the application versus those who have been less forthcoming.

According to one aspect, the platform may be directed to health care research and clinical trials. The platform could help ensure the fidelity of the information that people participating in the clinical trials provide to sponsors of the trial.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “survey” as used herein refers to a collection of one or more questions or prompts. They typically consist of a series of questions or prompts presented to respondents, covering various topics or aspects. Surveys often include a diverse range of question/prompt types, such as multiple-choice, open-ended, Likert scales, and/or the like. A survey may be administered using a variety of different methods including but not limited to verbally through direct questioning, digitally through an electronic interface, or physically through paper administration. A survey may comprise a payload with multiple elements. In some embodiments, the payload consists of a question (prompt) and two or more possible responses. In some embodiments, the payload consists of a question (prompt) and a location to input a response such as in the case of open-ended survey questions.

The term “poll” as used herein are brief and focused instruments designed to quickly gather opinions and/or preferences on specific topics. They are often characterized by simplicity and are commonly used for quick feedback. Polls are typically shorter in length compared to surveys, with a limited number of questions. Polls usually center around a specific question or a set of closely related questions.

The term “structure form” or “form” as used herein are digital documents designed to collect specific information in a systematic and organized manner. They can serve various purposes including data entry, registrations, applications, or feedback collection, to name a few.

### Conceptual Architecture

The computing system may further comprise one or more hardware processors configured for the execution of the various methods and processes described herein. Furthermore, the computing system may comprise non-transitory computer-readable storage media having computer-executable instructions embodied thereon that, when executed by one or more processors of the computing system employing a behavioral analysis platform, cause the computing system to perform the various methods and processes described herein. According to an embodiment, the various methods and processes described herein may be computer implemented methods.

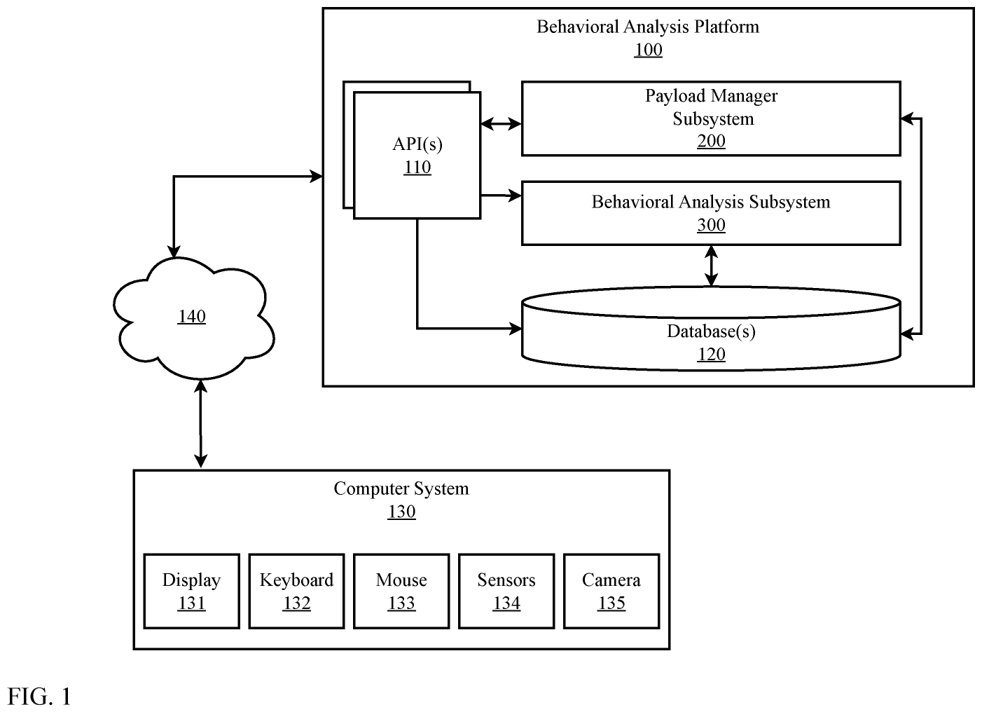

FIG. 1 is a block diagram illustrating an exemplary system architecture for a behavioral analysis platform, according to an embodiment. According to the embodiment, behavioral analysis platform 100 is be configured to improve the accuracy of polls and surveys by first optimizing the payload of an online or offline survey, poll, or any other structured form to enhance the effectiveness of capturing a plurality of behavioral data associated with a respondent to the survey, poll, or form, and then by using one or more trained machine and/or deep learning models to analyze the behavioral data to classify the responses with respect to various behavioral features including, but not limited to, conviction, veracity, and sentiment. According to the embodiment, behavioral analysis platform 100 comprises a payload manager subsystem 200 configured to assist with the planning and running of campaigns associated with surveys and/or forms, and a behavioral data analysis subsystem 300 configured to analyze the survey results using one or more geometric, statistical, and/or latent models to create a behavioral baseline for each respondent and compare the respondents measured behavior data against the baseline to determine a cognitive state such as but not limited to conviction, veracity, and/or sentiment of the respondent to a given survey question/response.

According to the embodiment, platform 100 further comprises one or more custom application programming interfaces 110 configured to capture behavioral data of a user as the user interacts with a survey and to render the survey payload elements in such a manner that optimizes behavioral data collection. Additionally, one or more database(s) 120 may be present and configured to store a plurality of information including, but not limited to, training data used to train the various behavioral/predictive models described herein, a plurality of user data (e.g., user baseline “fingerprint”, demographic data, historical response/behavior data, etc.), campaign data (e.g., campaign parameters such as objectives, target audience, baseline questions, subject, etc.), business outcome data (when available) and various other data. Database(s) 120 may be stored in the memory of a computing system or multiple computing systems, and/or may be stored in a non-volatile data storage system of a computing system. Database(s) 120 may be implemented using one or more various data storage system/techniques known to those with skill in the art.

According to the embodiment, behavioral analysis platform 100 may connect to one or more computer systems 130 via an appropriate communication network 140 such as the Internet.

The one or more computer systems 130 may be any suitable device and/or system that performs various computational tasks including, but not limited to, servers, mainframes, embedded systems, and personal computers. According to the embodiment, computing system 130 is a personal computer (e.g., desktop, laptop, workstation, etc.) comprising one or more hardware processors, a memory, a non-volatile data storage system, and various peripheral devices to facilitate the input and output of data. According to the embodiment, computing system 130 may comprise various output devices such as a display 131 which can display or produce results from the computer's processed data. Devices such as keyboards 132, a mouse 133, touchpads, and touchscreens allows users to input data into the computing system. For example, computing system may display a survey to a system user and the user can use the mouse to navigate on the display 131 to their answer. In an embodiment, a computer system user may answer a survey question using a mouse 133 to move across the screen from a starting location on the screen to another location on the screen corresponding to a response indicative of the user's answer. Other sensors 134 may be integrated or otherwise connected to computer system 130 and able to collect, measure, and transmit various behavioral data signals to platform 100. Additionally, computer system 130 may comprise a camera 135, a microphone, an operating system, a network interface, a memory, and various other functional components commonly found in computer/processing systems.

According to the embodiment, the platform 100 comprises one or more bespoke Application Programming Interfaces (APIs) 110 configured to enable continuous capture and extraction of behavioral measures from a survey, poll, or form open in the browser of a user computer system. In another embodiment, the plurality of bespoke APIs 110 may be configured to enable continuous capture and extraction of behavioral measures from an offline survey, poll, or form. In one embodiment, platform 100 may comprise a third party survey platform or an independently operated platform instead of API 110. The API may be configured to perform several operations. A first operation of the API enables the API to capture all user movements continuously without stop while a user is responding to survey/form questions; this can include movements generated by the user while responding to baseline and non-baseline survey questions. The API may gather time-series data related to user movement data (timing data related to how long it took the user to select a response, correlated to the movement path traced by the user's mouse/finger/etc.), wherein the user's movement may be tracked geometrically though space and through time. Additionally, or alternatively, the API may be configured to capture and extract other forms of haptic/movement data which may be generated while a user interacts with a survey/form. For example, there may be a pressure sensor integrated into the mouse of a computing system or integrated in some other location (mouse pad/track pad, the surface the user is sitting on) which can provide haptic pressure data to the API. Haptic pressure data can be used as an input when analyzing behavioral data of a user. As another example, a camera integrated with the computing system on which a user is taking a survey/from may be able to track the eye movements and/or facial expression of a user while they are responding to questions. Eye movement and/or facial data may be collected by the API and used as an input when analyzing behavioral data of a user.

The API 110 may further be configured to reposition survey elements on the page to optimize the page for behavioral analytics. In an embodiment, the API may be configured to reposition the survey questions and answers to maximize the white space on the page, thereby optimizing the page for extraction of behavioral analytics. Examples of transformations that may be performed on a survey payload can include rendering the survey answers horizontally on the left and right top corners of the page; rendering the survey question on the bottom of the screen; and rendering a “Next” button on the center of the page once a user selects an answer. Transformations are made while keeping in mind the ability of the system to potentially baseline an eventually displayed question. Transformations may be performed on a survey payload to render the survey question, survey answers, and the “Next” button anywhere on the page. In another embodiment, the survey answers may be rendered on the bottom or sides of the screen. Maximizing the whitespace on the survey/form enables the platform to collect behavioral analytics data to assess user cognitive states such as but not limited to veracity, conviction, and/or sentiment from surveys. The Next button forces users into the same place on the page to standardize the starting mouse/finger coordinates for every question. This standardization improves the quality of data captured by platform 100 by forcing the respondent to have to move their mouse/finger from the same location thereby increasing the window of time and space available to capture the movement data, and as a result, yields better predictive capabilities by the behavioral and optimization models employed by platform 100. It should be appreciated that the platform's data capture and analysis can be applied to any media type (e.g., words, images, videos, etc.) and is totally agnostic to survey topic and media type. Additionally, the platform may normalize behavioral response data which originate from a variety of devices, screen sizes, connection parameters, and other environmental factors. Any knowledge of a respondent's devices and attributes allow response data to be aggregated, even when sourced from different contexts.

In some embodiments, platform may monitor and process survey results in real-time and make dynamic adjustments to survey payload elements. According to the embodiment, payload manager subsystem 200 is configured to train, maintain, and operate one or more optimization models developed from machine and/or deep learning models/algorithms. The one or more optimization models may be configured to generate payload optimization recommendations which can be applied via an API to a survey, poll, or form. The payload optimization recommendations may include, but are not limited to, the placement of various payload elements (e.g., prompt element, response element, Next button element, slider element, click element, cursor element, etc.), the size of payload elements, the color of payload elements, the font of payload elements, the amount of white space, the shape of the white space, and/or the like. Optimization model recommendations may be used to render the payload elements of a survey via API 110.

According to an embodiment, the capabilities may be implemented onto a host page (a page which hosts a survey or form), which is able to aggregate all screen behavior relevant to the question. These data streams can be asynchronously sent to platform 100 where they are stored, processed, and analyzed. The data streams received from the APIs may be stored in database(s) 120 and/or sent to behavioral analysis subsystem 300 for processing and analysis.

According to the embodiment, payload manager subsystem 200 is present and configured to provide functionality directed to the planning of a survey, poll, or form campaign. Payload manager subsystem 200 may determine objectives, identity a target audience, perform baseline planning, and optimize payloads for enhanced behavioral analytics data collection. According to the embodiment, payload manager subsystem 200 is further configured to provide functionality directed to the execution of a campaign. Payload manager subsystem 200 may deliver payloads to targets (e.g., survey) and adjust payloads and target sets as the campaign runs via an API, third party platform, or independently operated platform.

According to the embodiment, platform 100 uses behavior analytics (via behavior models) to baseline each respondent thereby establishing a resting behavioral analytics “fingerprint”. This resting baseline can be used to compare core survey response metrics. A baseline for a respondent may be determined by beginning each survey with easy/non-cognitive burden questions to establish each survey respondent's personal baseline (e.g., analyze how each respondent instantly/instinctively responds to easy questions). In various embodiments, a respondent's personal baseline may be established by measuring and analyzing various behavioral elements/metrics/features including, but not limited to, mouse or finger trajectory, directional changes, response time (i.e., movement velocity and distance traveled), dwell time (i.e., total time spent on the page), hover time (i.e., time hovering over answers), transition time (i.e., how much time it takes to transition to the next question), any and all micromovements. After establishing a baseline, platform 100 then measures each user's resting behavioral analytics “fingerprint” against the behavioral results of the core survey/form questions (i.e., all non-baseline survey questions). The platform baselines each respondent against themselves to enable a plurality of analyses such as but not limited to anomaly detection (e.g., standard deviation analysis), of the baseline against the core questions. This allows the platform to detect sentiment shifts within an individual as well as group analysis.

The use of a baseline and comparison thereof against survey behavior represents an improvement to existing survey methodologies and enables hyper-precise understanding of individual respondents; measuring the baseline against core survey questions enables a way to understand individual signals of hesitation and equivocation. Is also enables comparative analysis of non-cognitive burden questions with heavier cognitive processing. Because of this nuanced and fundamental understanding of the individual, the platform can also produce more accurate audience segmentation and sentiment analysis, as well as group analysis.

Accordingly, an aspect of the embodiment may be directed to longitudinal analysis of behavioral data at the individual or group level. When platform 100 performs longitudinal studies the behavioral models enable the platform to detect subtle shifts in sentiment over time. This can have significant implications for platform users. For example, in elections, if a defined group of voters have consistently been supporting candidate, and all of a sudden a shift is discovered in that strong support, that information may be leveraged in a few ways.

According to the embodiment, behavioral analysis subsystem 300 is present and configured to provide functionality directed to analysis of campaign results and data associated thereof including both response and behavioral data associated with an individual or target group. Behavioral analysis subsystem 300 may provide deception, conviction, and/or sentiment results to users and may learn, at the client, demographic, and/or platform level to improve future campaigns. According to various embodiments, behavioral analysis subsystem 300 may be configured to train, maintain, and deploy one or more behavioral models configured to analyze a responder's data to determine the responder's behavior.

In some embodiments, the computer system 130 may be any digital device or channel such as a smart phone, tablet, or smart wearable device (e.g., watch, fitness tracker, etc.). In such embodiments, the mobile computing device can have but does not require mobile software which may be stored and operating on the mobile device. The mobile software is in communication with behavioral analytics platform 100 and able to display survey, poll, or form questions and collect behavioral data associated thereof. The mobile software may be configured to provide similar functionality as the API 110 in that it provides a graphic user interface (GUI) to mirror the data collection of survey behavioral analytics from computers on cell phones and tablets. The mobile software may be configured to transform and render survey payload elements in such a manner that optimizes for behavioral data capture. Additionally, the mobile software may be configured to “gamify” a survey question as a transformation applied to the payload. Because clicking is the inherent action on a mobile device, gamifying the survey questions allows the mobile software to capture behavioral data related to trajectory, micromovements, directional changes, etc. As an example of survey question or task-based assessment gamification, question payload elements may be gamified by rendering a ball at the bottom of the mobile screens and the respondent must user their finger to “pick up” the ball. Respondents must drag the ball to a prompt of their choice at the top left or right corner (or middle if a 3-option) of their screens. Once they have arrived at their desired answer, respondents “drop” the ball on to that answer. A Next button appears at a standardized location (e.g., the bottom of the screen) once the answer has been selected or the task has been completed. Behavioral data captured on a mobile device may be sent platform 100 where it is processed by one or more behavioral models to generate as output a behavioral classification. In embodiments wherein the mobile computing device does not utilize the mobile software, API 110 automatically detects if the user is taking the survey on a cell phone and renders the survey on a cell phone using drag/drop or other type of gamification.

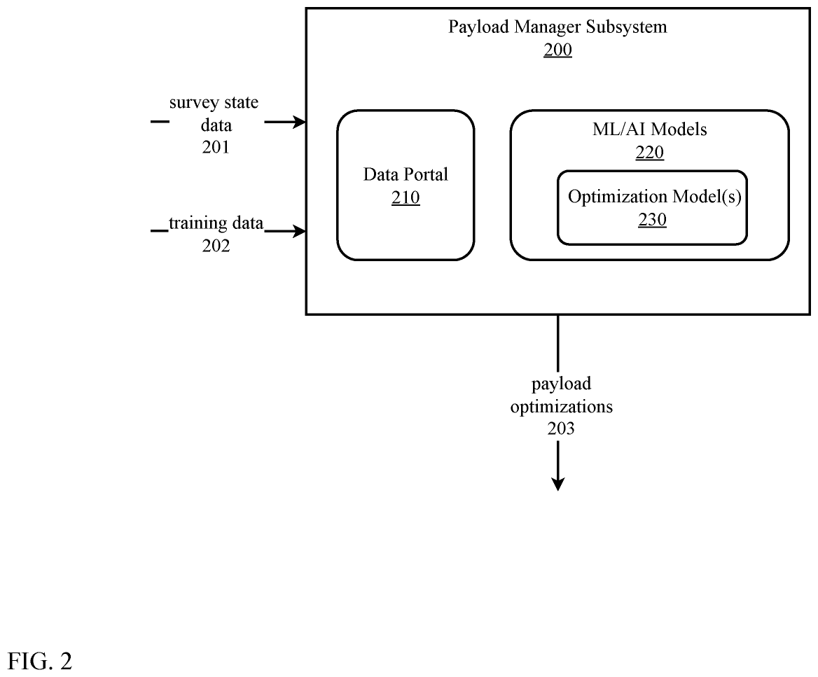

FIG. 2 is a block diagram illustrating an exemplary aspect of a behavioral analysis platform 100, a payload manager subsystem 200. According to the aspect, payload manager subsystem 200 may utilize one or more trained machine and/or deep learning models 220 to optimize the payload elements and data collection capabilities of platform 100. One or more optimization models 230 may be developed using a training dataset comprising a plurality of information from various sources. The training dataset 202 may or may not be stored in and retrieved from database 120. The training dataset may comprise a plurality of behavior data, campaign data (e.g., campaign parameters), behavioral science/psychology information, demographic data, conviction/veracity/sentiment prediction data, payload layout data, survey outcome and/or business outcome data, if available, and behavioral fingerprint data. The training dataset may be used to train one or more optimization models 230.

An optimization model directed to the optimization of payload layout may be developed using the training dataset. For optimizing the position of payload elements on a screen, a combination of machine and deep learning techniques may be implemented. In some implementations, reinforcement learning may be leveraged. In such an implementation, an agent may be developed which learns to make decisions by interacting with an environment. The agent receives rewards or penalties on its actions, guiding it towards optimal behavior. According to the implementation, a reinforcement learning environment is set up where the agent learns to position the elements on a screen, receiving rewards based on factors like user engagement, visual appeal, behavioral data collection maximization, or other specific design criteria. In an embodiment, the optimization model is directed to the optimization of binary questions on desktop and/or on a mobile device. In an embodiment, the optimization model is directed to the optimization of 3-option questions on a desktop and/or mobile device. In both cases, the arrangement of binary and/or 3-option questions may be optimized to maximize behavioral analysis data collection such that the respondent behaves in such a way that the platform can capture and analyze the respondent's underlying disposition.

According to another embodiment, the optimization models are developed using supervised learning with regression models to predict optimal positions for screen elements based on labeled training data. In such an embodiment, the optimization models are trained by providing the models with examples of screen layouts and their corresponding success metrics (e.g., user engagement, conviction, veracity, conversion rates, behavioral data collection maximization, etc.). The model learns to predict the optimal positions based on the input features. In some embodiments, the model may receive device data and use it as an input when optimizing the survey payload elements on the screen. For example, the optimization model may receive an indication that the survey is being performed on a tablet or mobile device and optimizes the layout of the payload elements for display on a tablet or mobile device, whereas the elements may be rendered differently if the survey was being performed on some other device such as a laptop.

The optimization models may be directed to the optimization of benchmarking questions, the optimization of the range of topics in the benchmark questions, and the optimization of how the benchmark questions are presented (e.g., the order in which the benchmark questions are presented).

According to the embodiment, a data portal 210 is present and configured to act as an interface between platform APIs, respondent devices, and the optimization models 230. Data portal 210 can be configured to receive data related to a survey or campaign and make dynamic adjustments to the execution of the survey as needed. Data portal 210 may receive survey state 201 information from an API and transform the survey state information into a suitable format for processing by the optimization models 230. Likewise, data portal may receive optimization model outputs such as payload optimizations 203 and format the model output into a format suitable for dissemination to an API where it may be applied to a survey. In some implementations, data portal 210 may be further configured to obtain campaign attributes from database 120 if available and determine campaign objectives, identify a target audience, perform baseline planning (e.g., benchmark question optimization), and optimize payloads for enhanced behavioral analytics collection.

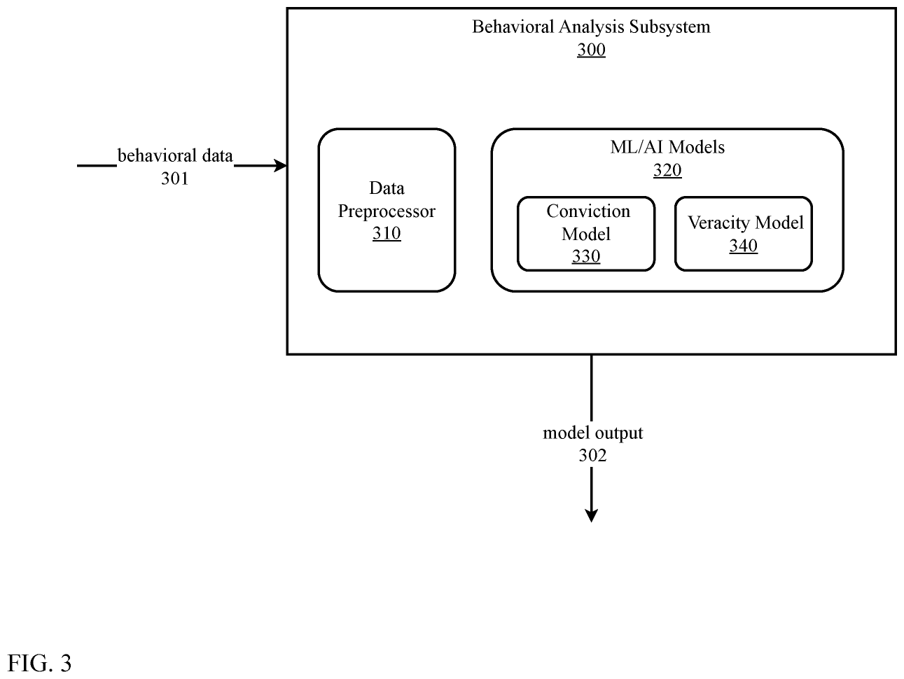

FIG. 3 is a block diagram illustrating an exemplary aspect of behavioral analysis platform 100, a behavioral analysis subsystem 300. According to the aspect, behavioral analysis subsystem 300 can receive a plurality of behavioral data 301 associated with a user response to a survey/poll/form from storage in database 120 or directly from an API source. Behavioral data may be received by a data preprocessor 310 and parsed to separate out the data associated with the baseline questions and the data associated with the non-baseline questions. In some embodiments, wherein the behavioral data comprises multiple data streams (e.g., biometric data, movement data, pressure data, etc.) data preprocessor 310 may be further configured to parse the multiple behavioral data streams each into individual streams for processing and storage. The data associated with the baseline questions may be first processed to establish a behavioral baseline “fingerprint” of a user. The baseline “fingerprint” may or may not be stored in database(s) 120 as part of a user profile. A user profile may be created by a user, or automatically with the consent of the user. A user profile may or may not store (in database 120) user demographic data, baseline “fingerprint” data, historical response data, and/or the like. In other embodiments, platform may not store any data and may instead, collect, process, and analyze the data before removing the data from the platform. The data associated with the non-baseline questions may be analyzed by the behavior model(s) and compared against the baseline fingerprint as part of the process to determine the user's behavior. The user's behavior may be determined for each question/response on a given survey/form. The user's behavior may be computed as an aggregate value based on the determined behavior for each question/response. The user's behavior may be computed as a numerical representation and may further comprise a numerical value indicating a confidence level in the numerical representation.

According to some embodiments, behavioral analysis subsystem 300 can provide behavioral analysis results including but not limited to deception, conviction, veracity, and/or sentiment results to users. This may be accomplished at the individual level (for example, wherein the form is related to an application for a job). This may be accomplished at the demographic level, using any available demographic category. This may be accomplished at the subject level such as different product options being evaluated in campaign, or different messages being assessed for use in marketing.

Behavioral analysis subsystem 300 may pre-process the obtained behavioral data (or training data) using a data preprocessor 310 and then use the preprocessed data as input into one or more machine/deep learning models 320 (referred to as behavioral models) configured to classify/predict a user behavior. An exemplary conviction model 330 and veracity model 340 are illustrated as examples of behavioral models which may be implemented in some embodiments of platform 100. These models are examples of possible cognitive state models. Behavioral models may exist for any physical or cognitive state which may be determined based on incoming behavioral data. Examples of data preprocessing steps that may be implemented can include data cleansing, normalization, attribute selection, discretization, data reduction, and/or the like. During model training operations, data preprocessing may further comprise splitting the input data into a training dataset, a validation dataset, and a test dataset. In some embodiments, a data preprocessing step may be directed to feature extraction/engineering wherein appropriate (e.g., geometric, statistical, latent, etc.) features are extracted to maximize the information gain when comparing two user responses instances (e.g., a baseline fingerprint to non-baseline data). These features may then be input into one or more geometric, statistical, or latent models trained to learn a numerical representation of each feature.

One of the core functionalities of behavioral analysis platform 100 is directed to baselining each respondent of a survey, poll, or form. In some embodiments, it may not be necessary to baseline each respondent depending on the goal of a particular survey, poll, task, or assessment. For example, if a field sobriety test is being conducted or a similarly situated medical assessment, baselining an individual may not be necessary. The behavioral analysis platform 100 may in some embodiments only baseline an individual when necessary to achieve the goal of survey, poll, task, or assessment.

The behavioral analysis subsystem 300 may utilize a plurality of models including but not limited to geometric, statistical, latent models 320 to process and analyze behavioral data of a respondent to characterize the behavior of a respondent. In an implementation, the models (e.g., conviction model 330, veracity model 340) may be configured to characterize user behavior related to present mental state regarding a plurality of a responses to a survey/form question. Cognitive states such as but not limited to conviction or veracity may be a determination of how sure a user is in their answer, how quickly they answer the question, and/or how much they entertain the answer set available. Veracity also derives from hesitancy, but may focus more on instances where someone changes their mind and patterns around wavering. The models for these types of behaviors are derived at least in part from a plurality of benchmarking questions shown to individuals, groups, and across survey cohorts, and the behavioral response data generated during their answer events. Benchmark questions may be designed to elicit responses of a specific benchmark of interest such as, for example, responses that are highly certain, high conviction, truthful, and spanning positive and negative variance. The benchmark question data can serve as a labeled training dataset for training the various behavioral and/or optimization models described herein. The benchmark questions/responses represent a labeled dataset because the behavioral model being trained with the training dataset would be aware of what benchmark of interest the question was supposed to elicit when analyzing the behavioral data associated with the response to that benchmark question. Using this training dataset, in combination with behavioral science/psychology information, the behavioral models can learn what typical benchmarks of interest tend to look like and how deviations from benchmarks reflect different types of behavior. In some embodiments, these learned benchmarks of interest are learned numerical representations of behavior which may be algorithmically processed to make predictions and classifications of respondent sentiment.

Additional dimensions of analysis may be similarly added. For example, additional dimensions/benchmarks of interest can include confident, assured, doubtful, highly uncertain, hesitant, skeptical, and/or the like. With sufficient benchmark surveys, users may be clustered by type and allow more effective clustering and classification of new users. There must be sufficient benchmark questions per user and per group of interest (i.e., cohort) to attain statistical power for the chosen analysis.

The data derived from the benchmark data may be benchmarked against itself or segmented into various groups for analysis and comparison. For example, platform 100 can benchmark at the individual respondent level, at a reference group level (e.g., a cohort which may be any definable class/group/subgroup of data), and at the global level using the entire dataset, both for a particular benchmark question, a real survey question (e.g., a non-baseline, non-benchmark question), and longitudinally across multiple surveys

In some implementations, optional core demographic and qualification questions may be provided to the user. The user responses to the core questions may be used to provide segmentation of the population of respondents for analysis.

In some implementations, behavioral science/psychology/psychographic information may be used as an input when training the behavioral models. Behavioral science and psychology literature provide valuable insights into various aspects of human behavior, including patterns of hesitancy, changes in answers, and other nuances related to cognitive states such as but not limited to conviction and veracity. Hesitancy often occurs during decision-making processes. Cognitive dissonance theory suggests that individuals may hesitate when faced with choices that conflict with their existing beliefs or values. Observing patterns of hesitancy, especially when the survey questions touch upon sensitive or conflicting topics, may provide insights into the respondent's internal struggles and decision-making processes. Cognitive dissonance can lead individuals to change their answers to align with their beliefs or reduce discomfort. This is known as post-decisional dissonance. Tracking changes in answers, especially if they occur after certain types of questions, can indicate cognitive dissonance. This may be relevant when assessing veracity. Faster response times are often associated with higher confidence in answers, while prolonged response times may indicate uncertainty or cognitive load. Analyzing response times can provide a proxy for confidence levels. Quick responses may be associated with strong convictions, while longer response times might indicate uncertainty or contemplation. Micromovements, including subtle gestures and facial expressions, can convey information about a person's state of mind. Nonverbal cues play a significant role in communication. Integrating data on micromovements into the analysis can help capture nonverbal cues associated with conviction or hesitancy. Consistency in responses is often associated with perceived truthfulness. Inconsistencies may raise questions about the veracity of answers. The model may track consistency across responses to identify respondents who may be providing conflicting information. The way questions are framed can influence responses. Priming effects occur when previous questions or external cues influence subsequent answers. The behavioral models may consider how the framing of questions and contextual priming may impact responses and contribute to patterns of hesitancy or changes in answers. These insights provide a foundation for understanding the behavioral nuances related to conviction and veracity. Integrating them into the analysis can enhance the accuracy of behavioral classification models.

In various implementations, the behavioral models may be trained using a training dataset comprising a plurality of benchmark questions, a plurality of behavioral science/psychology/psychographic information, a plurality of behavioral data (e.g., mouse/finger movement data) associated with the benchmark questions, and core demographic data, if applicable.

The behavioral models may comprise a machine leaning or deep learning model. Classifying the cognitive state such as but not limited to conviction or veracity of survey responders based on various data streams of behavioral data involves analyzing complex patterns and interactions. Examples of machine learning models/algorithms that may be used in various embodiments include, but are not limited to, random forest, gradient boosting, neural networks, hidden Markov models, ensemble methods feature engineering, and/or the like. In an embodiment, a neural network may be configured on training data comprising a plurality of benchmark questions and related behavioral data and behavioral science data. For example, a long short-term memory (LSTM) neural network may be suitable for sequential data by capturing temporal dependencies. LSTMs can be effective when dealing with time-series data such as mouse or finger trajectory, response time, and micromovements.

In an embodiment, a convolutional neural network (CNN) may be configured to analyze spatial data such as mouse or finger trajectory data. CNNs can learn spatial hierarchies and patterns, making them suitable for analyzing directional changes and trajectory and making predictions based on analysis thereof.

According to some implementations, the ML/AI models 320 may comprise one or more sequential models such as recurrent neural networks or hidden Markov models. In an embodiment, a hidden Markov model (HMM) may be configured to model temporal dependencies and transitions between states. HMMs can be applied to capture patterns in transition times and dwell times.

In some embodiments, ensemble methods may be used wherein multiple models are combined (e.g., random forest, gradient boosting, LSTM, etc.) to provide a more reliable classification by leveraging the strengths of different models across a complex and diverse dataset. For example, a random forest and/or gradient boosting models may be implemented for handling the diverse set of features and capturing complex interactions, and additionally a LSTM and/or CNN may be developed for modeling sequential and spatial aspects of data, such as mouse or finger trajectory, transition and dwell times, and/or the like.

The behavioral models may be configured to analyze behavioral data comprising trajectory and timing data associated with mouse/finger movement. According to an embodiment, geometric and statistical processing may be applied to paths and additional available data streams (e.g., biometric data, sensor data, etc.) to normalize the “user answer event” such that all answers may be directly compared in an n+1 sized hypercube where n is the number of data streams and +1 is the timing data. Once the trajectory and timing data have been decomposed into a feature-space, which can be extended with any feature or feature types commonly used including, but not limited to, a broad set of geometric features, trend-based features, and features based on baselining differentials, the data are essentially a statistical representation of the “answer event”.

### Detailed Description of Exemplary Aspects

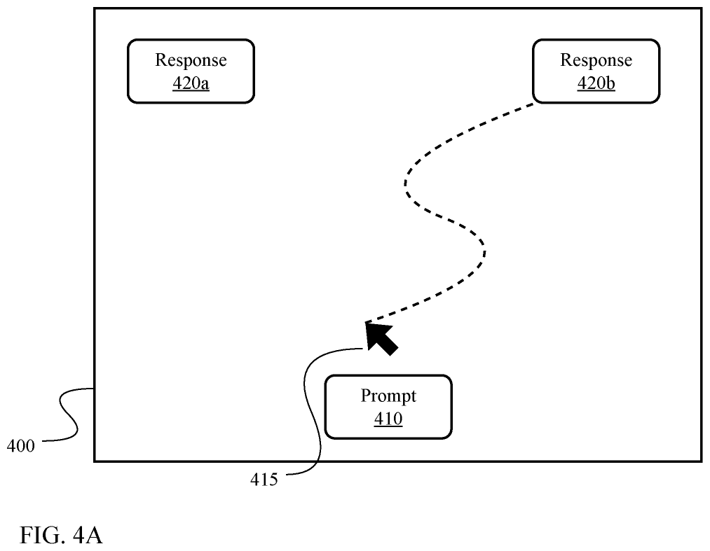

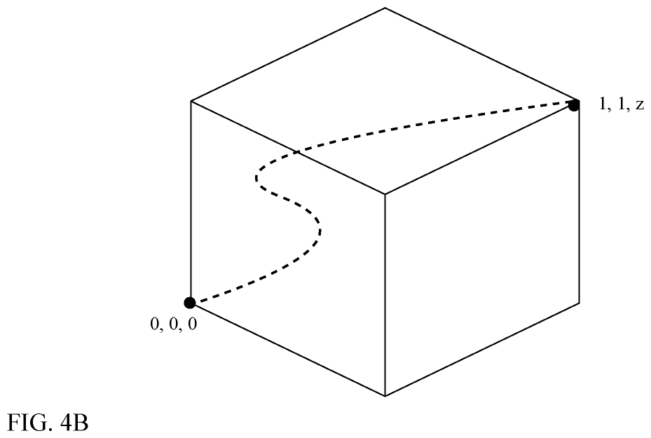

FIG. 4A is block diagram illustrating exemplary data capture of an answer event on a user device 400, according to an embodiment. The user device may be a computing system (e.g., PC or laptop) or a user mobile device (e.g., smart phone or tablet) or any other device able to serve spatio-visual stimuli to a user. According to a preferred embodiment, the user uses a browser on their computing device to respond to a survey, poll, or form which may be online or offline comprising one or more questions. An API may be present which can collect and extract various behavioral data that is generated while the user is interacting with the survey and can also transform the survey payload elements as necessary. The user interaction with a survey question, including the timing data, trajectory data, and any other data streams that may be collected during the selection of a response to a question may be referred to herein as “user answer event”. According to the embodiment, a binary question layout is shown as comprising a prompt 410 at the bottom center of the screen and two responses 420a, 420b being rendered at the top left and right corners of the screen. In another embodiment, the layout may reflect a prompt or a task rather than a question. The layout can be oriented as shown, but is in no way limiting to the possible arrangement of elements that may be possible. For example, the layout may be flipped wherein the prompt 410 is at the top of the page and the responses at the bottom corners. Another exemplary transformation may render the prompt on one side of the page and the two responses on the top and bottom corners of the other side of the page. According to the embodiment, the payload layout of the binary survey page was rendered based at least at part on a recommendation from one or more optimization models. In each embodiment, the layout models may be aware of the statistical requirements of the resulting data. As such, each model may take a form where collecting resulting data is possible.

The prompt 410 and responses 420a, 420b can be text, images, multimedia, or any other content type. In an embodiment, the prompt may comprise a survey question and the responses may comprise the survey answers. The system and methods described herein can accommodate two or more responses being rendered on the page. The cursor 415 or other pointing mechanism (e.g., drag-and-drop ball) may be configured to start at a standardized position. Initially, the cursor may be placed at the standardized location on the screen by the API and then placed at that location again every time the Next button is selected. The standardized location may be determined based at least in part on the purpose, scope, or type of campaign associated with the survey/form, a demographic, by survey cohort, by subject (for example, different product options being evaluated in a campaign, or different messages being assessed for use in marketing), behavioral data comparisons, timing data, cognitive analysis data, or various other considerations associated with a campaign. The standard starting location and/or the location of the Next button may be determined based at least in part on a recommendation from one or more optimization models. In some implementations, the standardized location may be dynamically adjusted based on at least in part on the purpose, scope, or type of campaign associated with the survey/form, a demographic, by subject (for example, different product options being evaluated in a campaign, or different messages being assessed for use in marketing), behavioral data comparisons, timing data, cognitive analysis data, or various other considerations associated with a campaign.

It should be appreciated that the standardized location may also be applied to virtual reality environments using visual tracking, brain-computer interfaces, joysticks, etc., or any other means to interact and provide input to a computing system for the purpose of responding to a survey or form.

During operation the API accurately and continuously captures the user's path (illustrated as the dashed line) made by the cursor 415 from the prompt 410 to their ultimate decision along with timing data related to the movement and other haptic and environmental data (e.g., pressure of touch, eye movement, facial expression, keystroke, etc.) as available.

FIG. 4B is a diagram illustrating a n-dimensional hypercube comprising the decomposed behavioral data associated with the respondent's answer event of FIG. 4A, according to an embodiment. According to the embodiment, the path through the hypercube may represent decomposed trajectory and timing data associated with the answer event. Various geometric and statistical processing may be applied to the path to normalize the user answer event such that it may be directly compared against other paths. The decomposed path may be analyzed to determine a numerical representation of the behavioral data related to the answer event. This numerical or statistical object can be processed algorithmically using one or more behavioral models to classify or regress its properties against an expectation of the universe of known answers, to understand how it differs along the axes of interest (e.g., conviction, veracity, etc.).

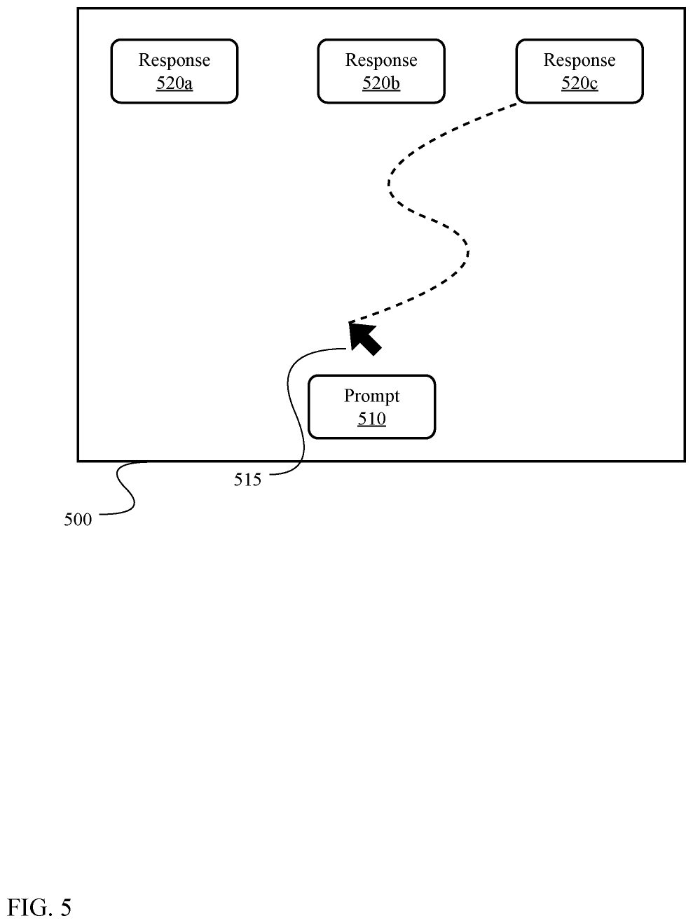

FIG. 5 is a block diagram illustrating exemplary data capture of an answer event on a user device 500, according to an embodiment. The user device may be a computing system (e.g., PC or laptop) or a user mobile device (e.g., smart phone or tablet) or any other device able to serve spatio-visual stimuli to a user. According to a preferred embodiment, the user uses a browser on their computing device to respond to a survey, poll, or form comprising one or more questions. An API may be present which can collect and extract various behavioral data that is generated while the user is interacting with the survey and can also transform the survey payload elements as necessary. The user interaction with a survey question, including the timing data, trajectory data, and any other data streams that may be collected during the selection of a response to a question may be referred to herein as “user answer event”. According to the embodiment, a 3-option question layout is shown as comprising a prompt 410 at the bottom center of the screen and three responses 520a, 520b, and 520c being rendered horizontally across the top of the screen with a response element at the left and right corners and one in the center of the screen. The layout can be oriented as shown, but is in no way limiting to the possible arrangement of elements that may be possible. For example, the layout may be flipped wherein the prompt 410 is at the top of the page and the responses at the bottom corners. Another exemplary transformation may render the prompt on one side of the page and the two responses on the top and bottom corners of the other side of the page. According to the embodiment, the payload layout of the 3-option survey page was rendered based at least at part on a recommendation from one or more optimization models.

The prompt 510 and responses 520a, 520b, and 520c can be text, images, multimedia, or any other content type.

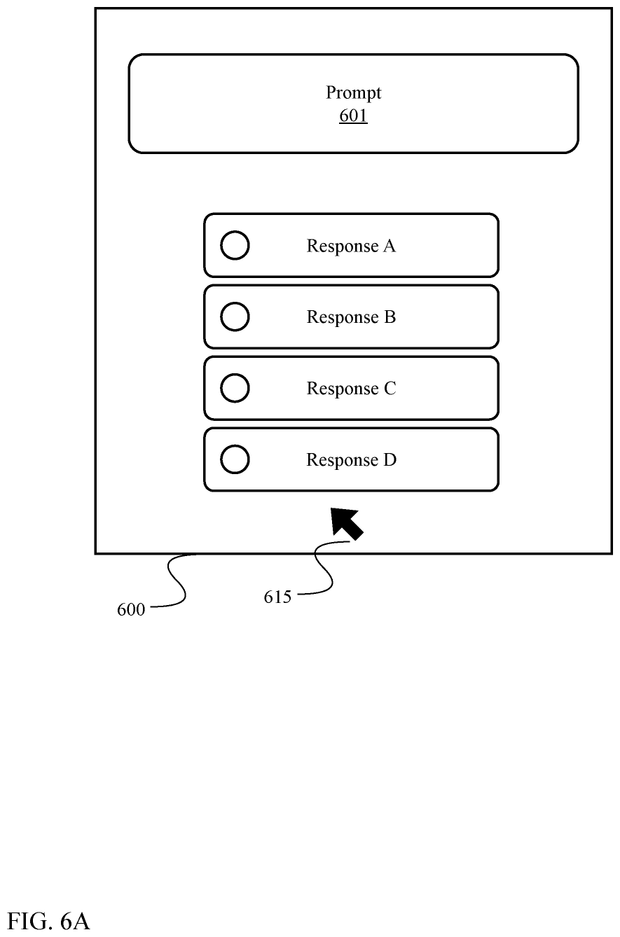

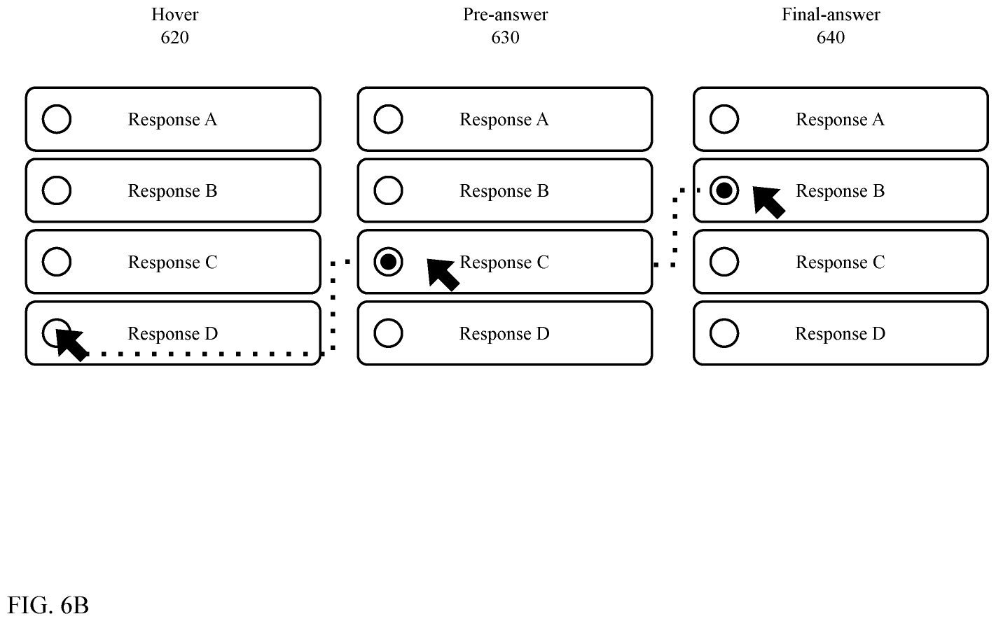

FIG. 6A is a diagram illustrating an exemplary multiple-choice survey, poll, or form payload format that may be implemented in some embodiments and the capture of behavioral data associated thereof. Platform 100 can be configured to enhance surveys, polls, or forms which utilize multiple-choice type prompts and responses. A user device 600 may use an Internet browser to access a survey and display a multiple-choice question prompt 601. An API may be present and configured to optimally arrange the elements of the multiple-choice question to enhance behavioral analysis data collection. For example, a cursor 615 may be placed in a standardized starting location wherein the location is based at least in part on a recommendation from one or more optimization models.

FIG. 6B illustrates an exemplary answer event for the multiple-choice question, according to an embodiment. This exemplary multiple-choice answer event comprises three distinct stages: an initial hover stage 620, an intermediate pre-answer stage 630, and a final-answer stage 640. The API continuously captures and extracts the movement/trajectory and timing data associated with the cursor movement while the device user responds to the prompt 601. Initially, the user (responder) moves the cursor over to and hovers over the selection circle corresponding to the “Response D” answer without ever clicking or otherwise selecting that answer. Next, the user moves the cursor over to the “Response C” answer and clicks/selects it as their response, however, the user does not submit this response for whatever reason. For example, maybe there is a prompt of confirmation when an answer is selected and the user chooses to not confirm which causes the user to have to make another choice. In an embodiment, the Next button may appear when a user selects an answer and the user may submit their answer by selecting/clicking on the Next button. In any case, the user then moves the cursor from the “Response C” answer to the “Response B” answer and clicks/selects is as their final response. The API is collecting various behavior data during this entire user answer event. The provided responses are merely exemplary and do not represent the extent of the types of responses that may be included in various aspects of a multiple-choice question/prompt.

The behavior data collected during the answer event comprises at least user movement data and timing data (as well as clicking input data, available haptic data, biometric data, and various sensor data). This data represents a rich source of contextual and behavioral data which is not possible to obtain using traditional survey systems and methods. Traditionally, the only data obtained from such surveys was the user's final answer as “Response B” and does not capture any of the respondent's underlying behavioral inputs when selecting that response. For example, the behavioral data captured in FIG. 6A may be analyzed by one or more behavioral models configured to classify the response with respect to cognitive states such as but not limited to conviction and/or veracity. The system may decompose the trajectory and timing data into an n-dimensional path and use geometric and statistical processing to classify the behavior of the respondent. Behavioral data may be compared against a user behavioral fingerprint to determine a behavioral response (i.e., conviction, veracity, and/or sentiment).

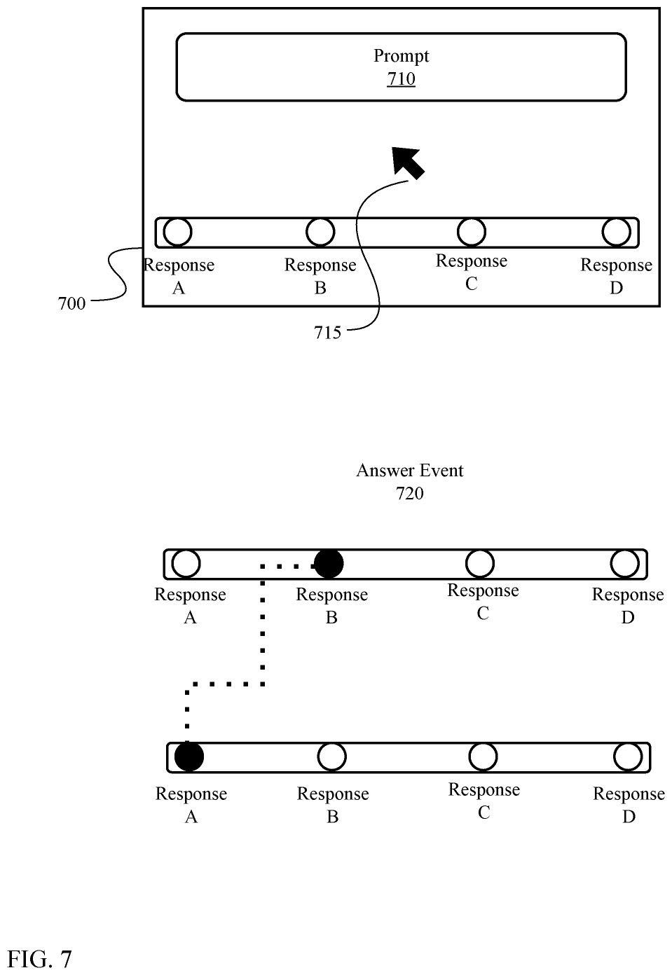

FIG. 7 is a diagram illustrating an exemplary slider question survey, poll, or form payload format that may be implemented in some embodiments and the capture of behavioral data associated thereof. Platform 100 can be configured to enhance surveys, polls, or forms which utilize slider type prompts and responses. A user device 700 may use an Internet browser to access a survey and display a slider type question 710. An API may be present and configured to optimally arrange the elements of the multiple-choice question to enhance behavioral analysis data collection. For example, a cursor 715 may be placed in a standardized starting location wherein the location is based at least in part on a recommendation from one or more optimization models. The API continuously captures and extracts the movement/trajectory and timing data associated with the cursor movement while the device user responds to the question 710.

An exemplary user answer event 720 associated with the slider question 710 is shown. The movement and timing data associated with the answer event is captured by the API and processed by one or more behavioral models of behavioral model platform 100 to determine a behavioral feature associated with the response. In some embodiments, the behavioral feature is associated with conviction, veracity, and/or sentiment.

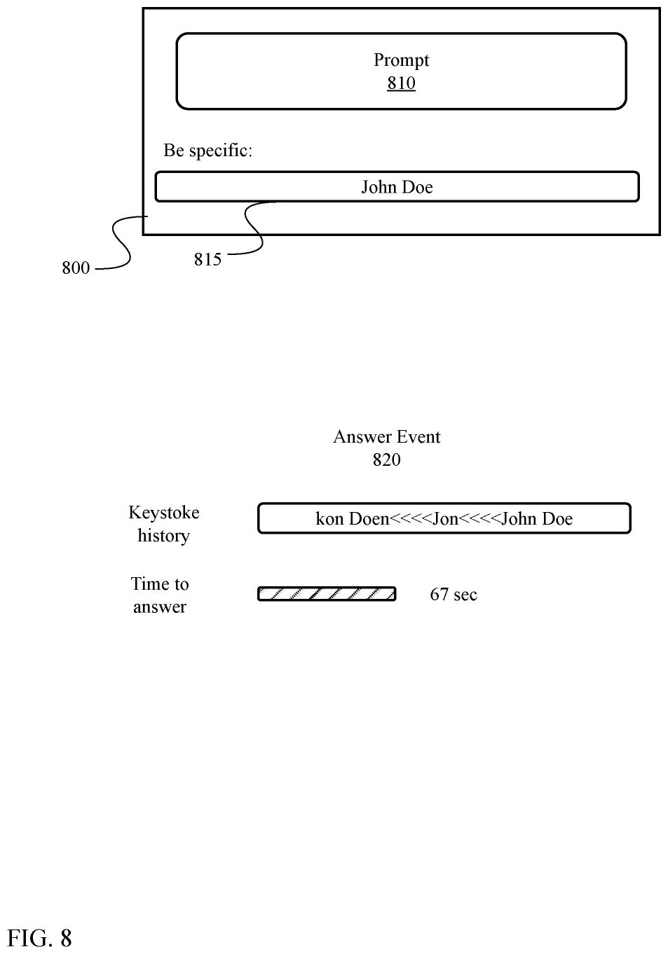

FIG. 8 is a diagram illustrating an exemplary open-ended question survey, poll, or form payload format that may be implemented in some embodiments and the capture of behavioral data associated thereof. Platform 100 can be configured to enhance surveys, polls, or forms which utilize open-ended type prompts and responses. A user device 800 may use an Internet browser to access a survey and display an open-ended type of question 810. An open-ended type of question does not have pre-determined responses, but requires the device user to fill in a response, in this exemplary case a typed response using a keyboard connected to the user device. A response area 815 is rendered so that the user may input a response. An API may be present and configured to optimally arrange the elements of the open-ended question to enhance behavioral analysis data collection. The API continuously captures and extracts any movement/trajectory and timing data associated with the cursor movement while the device user responds to the question 810. Because it is an open ended question, additional behavioral data may be collected, the additional behavioral data comprising keystroke data associated with the user response.

An exemplary user answer event 820 associated with the open-ended question 810 is shown. The keystroke and timing data associated with the answer event is captured by the API and processed by one or more behavioral models of behavioral model platform 100 to determine a behavioral feature associated with the response. In some embodiments, the behavioral feature is associated with conviction, veracity, and/or sentiment. In this case, the behavioral models may determine that the user answered with high conviction and veracity, as the behavioral data indicates that the user only had one answer (with spelling mistakes) and started to input the answer quickly once the page was loaded.

It should be appreciated that the data capture and analysis methodologies used for open-ended questions can be applied to any/all structured forms or static forms.

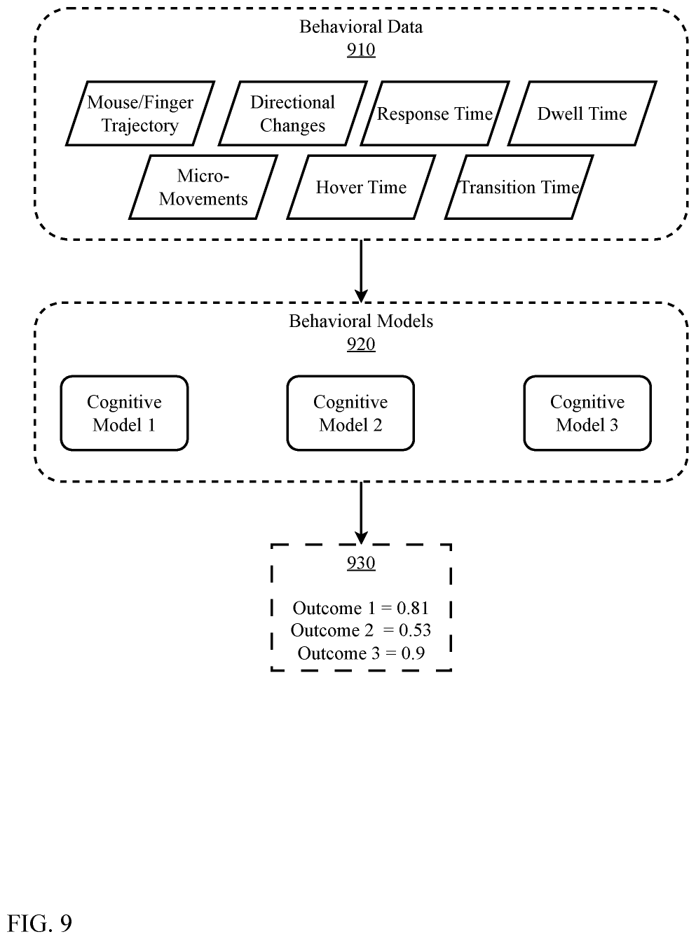

FIG. 9 shows an exemplary behavioral model result produced by one or more trained behavioral models based on received behavioral data, according to the embodiment. Behavioral data 910 is generated by a respondent during an answer event associated with a response data collection form (e.g., survey, poll, etc.), or in other words, the behavioral data is data collected while a survey taker responds to a question on a survey. The behavioral data 910 may be collected by an API which can render the survey question elements in an optimal arrangement to facilitate behavioral data collection and then send the collected data to platform 100 where it may be processed by one or more behavioral models 920. According to the embodiment, behavioral data 910 comprises a plurality of data including, but not limited to, keystroke patterns, changes of answers, mouse/finger trajectory, directional changes, response time, dwell time, micro-movements, hover time, and transition time. The set of behavioral data related to standard questions, multiple-choice, and slider questions may be referred to collectively as trajectory and timing data and may be decomposed into a path in an n-dimensional feature space, according to some embodiments.

The behavioral data 910 may be pre-processed and/or stored when it is received at platform 100. The data may be pre-processed geometrically, statistically, latently, etc., to prepare the data for processing by the one or more behavioral models 920. For example, data may be decomposed into a feature space, vectorized, or otherwise transformed into a format suitable for processing. The trained models may comprise a trained conviction model, a trained veracity model, and a trained sentiment model. Various other models may be developed depending upon the use case, application, and embodiment. The behavioral models 920 process the behavioral data against the plurality of learned behaviors to make one or more classifications/predictions of the respondent's behavior. An exemplary model output 930 which may be generated in various embodiments is shown. The model output 930 as shown may be model output which has been slightly post-processed to make it more readable and presentable to a platform user and/or respondent. In one embodiment, the values 0.81, 0.53, and 0.9, may correspond to a respondent's conviction, honesty, or general outlook about the overall question. Certainty, honesty, and overall feeling are generalized variations of respondent characteristics that may be calculated using the behavioral model 920. Additionally, the values produced by the generated model output 930 will vary depending on each respondent's behavioral data. The model output 930 may be reported to a platform user via a user interface where it may be displayed and otherwise interacted with. The model output 930 may be reported to the survey responded via a display of their computing device.

It should be appreciated that various other types of behavioral data may be collected by platform 100 during an answer event. In some implementations, additional behavioral signals can be collected and analyzed including, but not limited to, eye movement, key stroke analysis, stylus analysis (i.e., grip analysis, pressure, trajectories, micromovements, handwriting analysis), heart rate, facial movement coding, sweat gland measurement (e.g., skin conductance sensor analysis), lip movement analysis, gait analysis, posture detection, breath pattern analysis, and/or the like. In embodiments utilizing mobile devices/wearables to capture behavioral data, the additional behavioral data can include mobile device activity analysis (e.g., swiping, clicking, zooming, hovering, dragging, and flipping pattern analysis), mobile device sensors (e.g., gyroscope, accelerometer, heart rate sensors, temperature sensors, Lidar sensors, cameras, microphones, global positioning sensors, etc.), and smart watch and other wearable sensor extraction.

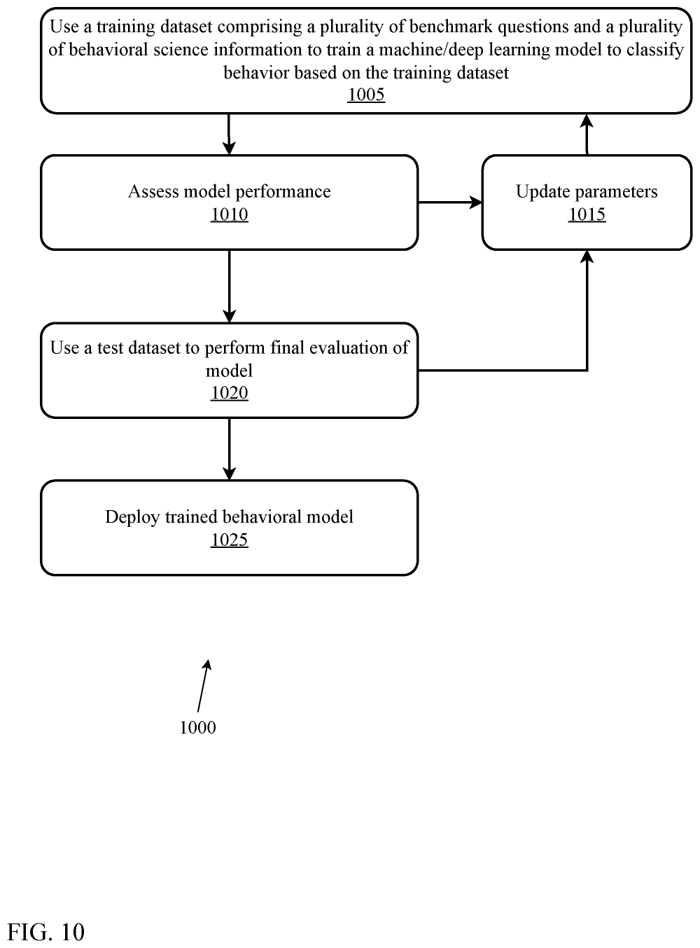

FIG. 10 is a flow diagram illustrating an exemplary method 1000 for training a behavioral model to make behavioral predictions, according to an embodiment. The process may be carried out by one or more processors of platform 100 or one of its components. According to the embodiment, the process begins at step 1005 by using a training data comprising a plurality of benchmark questions and a plurality of behavioral science/psychology/psychographic information to train a machine and/or deep learning model to classify behavior of a respondent during an answer event corresponding to a survey, poll, or form. In some embodiments, the training dataset consists of labeled examples (i.e., benchmarks), where the input data is paired with a corresponding correct output label. The model learns to make predictions based on this training data. At step 1010, the model undergoes continuous and iterative training and performance assessment. The model may be assessed in various ways known to those with skill in the art. One method to assess the model performance is calculate and then try to minimize the difference between the model's predictions and the actual labels in the training data. Another form of assessment utilizes validation datasets. At regular intervals during training, the model's performance is evaluated on the validation dataset. This involves using the current state of the model to make predictions on the validation data and comparing those predictions to the true labels. The validation performance serves as a metric to monitor the model's ability to generalize to new data. The validation dataset helps detect overfitting, where a model performs well on the training data but fails to generalize to new data. If the model's performance on the validation set starts to degrade while improving on the training set, it may be a sign of overfitting. If the model is not meeting performance requirements then the model parameters may be updated at step 1015.

Validation performance is often used to fine-tune hyperparameters, such as learning rates or model architecture. By adjusting these parameters based on validation results, the model's generalization performance can be optimized. During the training process, the model is iteratively updated based on its performance on the training dataset. Once the model is trained and hyperparameters are tuned, it is typically evaluated on a separate test dataset that it has never seen before. This final evaluation provides an unbiased assessment of the model's performance on completely new data. At step 1010 a test dataset is used to perform a final evaluation of the model. If the model fails the test step, then then the model parameters may be updated 1015 and the training process continues. If the model passes the final test, then it may be deployed as a trained behavioral model in a production environment at step 1025 wherein it can make predictions/classifications one real behavioral survey data. The deployed model performance may be monitored. The deployed model outputs may be captured and used as further training data for this and/or other behavioral/optimization models described herein, wherein the models may refine their predictive/classification capabilities overtime through continuous learning.

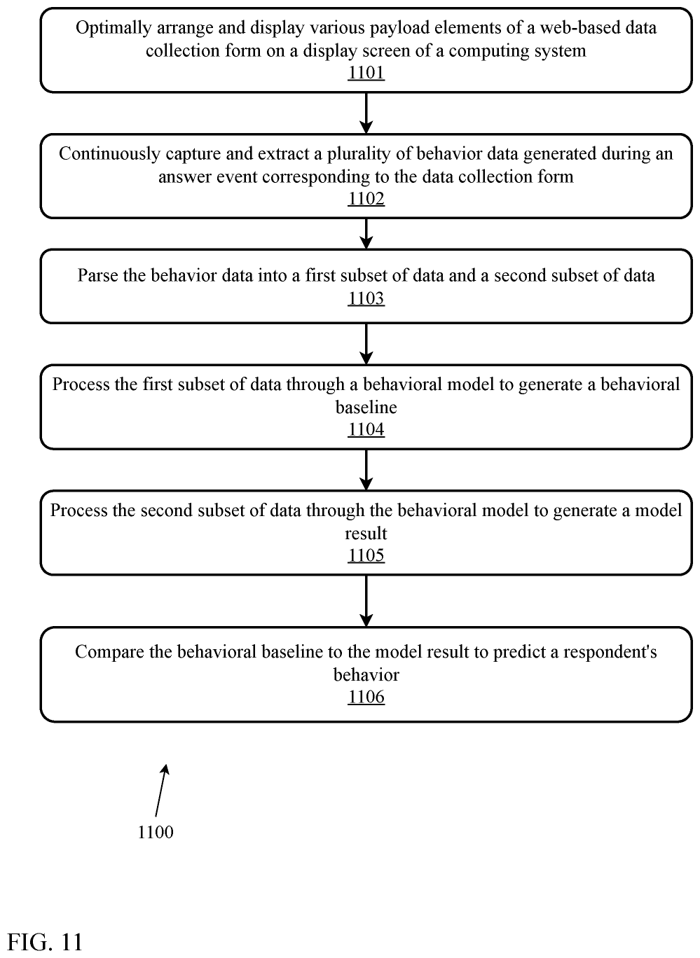

FIG. 11 is a flow diagram illustrating an exemplary method 1100 for performing collecting and analyzing behavioral survey data, according to an embodiment. According to the embodiment, the process begins at step 1101 when an API 110 optimally arranges and displays various payload elements of a data collection form (e.g., survey, poll, or structured form) on a computing system such as a desktop computer or a mobile device such as a tablet. The API may receive optimization recommendations from an optimization model, wherein the optimization recommendations are used in part to determine the placement of the various payload elements including a cursor element, a prompt element, and two response elements (in binary questions) or three response elements (in 3-option questions). The data collection form may be implemented as a survey, poll, or other type of structured/static form. The computing system may operate a web browser to access the survey. The API may integrate with the browser and the computing system to collect and extract a plurality of behavioral data. At step 1102, the platform 100 via API 110 continuously captures and extracts a plurality of behavior data generated during an answer event corresponding to the data collection form. That is to say, the API collects all available behavioral data generated while a survey responder selects an answer to a survey question.

The captured behavioral data may be transmitted to platform 100 where it may be stored, transformed, otherwise processed by one or more components of platform 100. In an embodiment, the behavioral data is parsed into a first subset of data and a second subset of data at step 1103. In various implementations, the first subset of data may comprise behavioral data corresponding to baseline/benchmark questions which may be placed at the beginning of each survey by the API. The second subset of data may comprise behavioral data corresponding to non-baseline or “real” survey questions. At step 1104, the first subset of data is processed by one or more behavioral models to generate a behavioral baseline or behavioral fingerprint of the respondent. At a next step 1105, the second subset of behavioral data is processed by the one or more behavioral models to generate a model result. As a last step 1106, data analysis platform 100 compares the behavioral baseline to the model result to predict the respondent's behavior during the answer event. The predicted behavior may be reported to a platform user and/or to the survey respondent via an appropriate user interface and display.

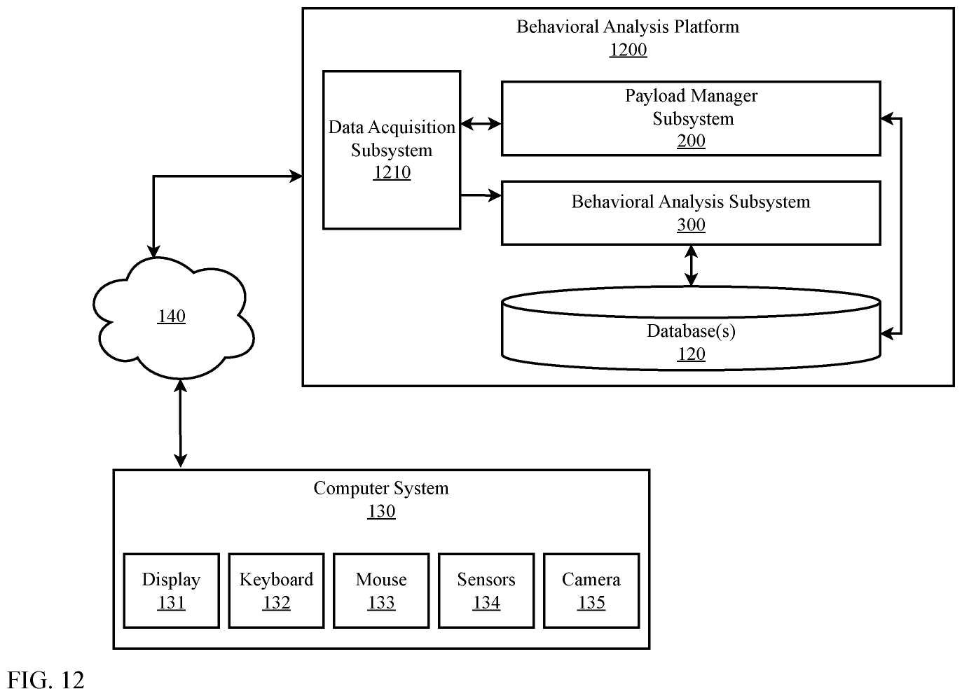

FIG. 12 is a block diagram illustrating an exemplary system architecture for a behavioral analysis platform utilizing a data acquisition subsystem 1210, according to an embodiment. According to the embodiment, behavioral analysis platform 1200 is be configured to improve the accuracy of polls and surveys by first optimizing the payload of an online or offline survey, poll, assessment, task, or any other structured form to enhance the effectiveness of capturing a plurality of behavioral data associated with a respondent to the survey, poll, or form, and then by using one or more trained machine and/or deep learning models to analyze the behavioral data to classify the responses with respect to various behavioral features including, but not limited to, conviction, veracity, and sentiment. According to the embodiment, behavioral analysis platform 1200 is configured to provide the same functionality of platform 100 of FIG. 1, however, platform 1200 comprises data acquisition subsystem 1210 in place of APIs 110. Data acquisition subsystem 1210 may be configured to provide the same functionality of APIs 110 including the continuous collection and extraction of behavioral data during an answer event corresponding to a response to a survey, poll, form, assessment, or task. Data acquisition subsystem 1210 may also render various payload elements of a question in an optimal way based at least in part on a recommendation received from payload manager subsystem 200. Data acquisition subsystem 1210 may send behavioral data behavioral analysis subsystem 300 for processing by one or more behavioral models.

In some embodiments, data acquisition subsystem 1210 may be configured to provide a survey, poll, assessment, task, or form selected from a plurality of stored surveys, polls, or forms in database 120.

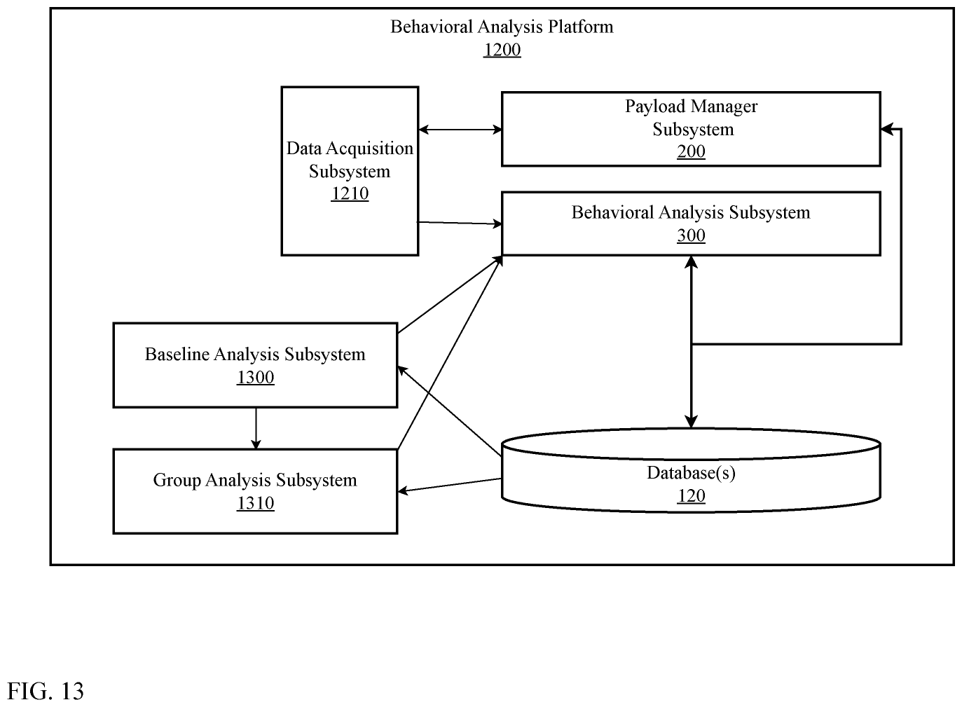

FIG. 13 is a block diagram illustrating an exemplary system architecture for a behavioral analysis platform utilizing a baseline analysis subsystem 1300 and a group analysis subsystem 1310, according to an embodiment. The behavioral analysis subsystem 300 may generate a baseline “fingerprint” for each respondent which may or may not be stored in a plurality of databases 120. The baseline “fingerprint” for each respondent may be created based on metric data collected during the administration of baseline questions. Metric data may include but is not limited to; mouse and finger trajectory, response and dwell time, hover or transition time, key stroke speed, key stroke pattern, and the number of clicks or deletes. In another embodiment, metric data may include the user's biometric data gathered by the user's mobile device or an electric biometric data collector connected to the user's mobile device. Biometric data may include pulse, facial color and patterns, eye tracking including dilation tracking, or breathing pattern tracking. The baseline analysis subsystem 1300 may access a respondent's behavioral baseline “fingerprint” either directly or from the plurality of databases and analyze baseline trends for a respondent. All subsequent baseline questions and collected metric data may be analyzed with respect to a respondent's initial baseline “fingerprint”.

The baseline analysis subsystem 1300 may generate new baseline questions for a respondent based on how recent respondent metric data deviates from their initial baseline “fingerprint”, if at all. New baseline questions may be used to update a respondent's behavioral baseline “fingerprint”. Responses and metric data associated with new baseline questions may be sent to the behavioral analysis subsystem 300 where an updated behavioral baseline “fingerprint” may be created for a respondent. The new behavioral baseline “fingerprint” may or may not be stored in the plurality of databases 120 where the baseline analysis subsystem 1300 may access them. This process may continue indefinitely to ensure a respondent's behavioral baseline “fingerprint” accurately reflects a respondent's physical and cognitive state as best as possible. To ensure accurate behavioral baseline “fingerprints”, the baseline analysis subsystem 1300 may generate new baseline questions periodically or when certain criteria has been met. In one embodiment, the baseline analysis subsystem 1300 may generate a new baseline question for the respondent when the behavioral analysis subsystem 300 makes an incorrect prediction about how a respondent would respond to a given non-baseline question. In another embodiment, baseline questions may be interleaved throughout non-baseline questions to ensure a respondent's behavioral baseline “fingerprint” remains as accurate as possible, even if no drift from their original baseline fingerprint has been explicitly detected.

Additionally, individual behavioral baseline “fingerprints” may be tracked over time over a variety of different encounters. Encounters may include a survey but may vary depending on the form a baseline question takes. In one embodiment, a baseline question may be administered through a survey mobile software which may or may not be brand centric. In one embodiment, the baseline analysis subsystem 1300 may access respondent data through a respondent's activities outside of a particular survey. In another embodiment, respondent data related to verbal questioning may be processed by the baseline analysis subsystem 1300. Tracking respondent data and creating behavioral baseline “fingerprints” from data received through a variety of mediums may provide an enhanced, more reliable behavioral baseline “fingerprint” for a respondent. More holistic data about a respondent's patterns and tendencies leads to more accurate predictions for future behavior.

In another embodiment, a group analysis subsystem 1310 may compile and analyze data for individual respondents either directly or from the plurality of databases 120 or by the baseline analysis subsystem 1300. Individual respondents may be grouped together by the group analysis subsystem 1310 based on a variety of factors including but not limited to, age, gender, socioeconomic status, political affiliation, religious preference, and overall similarity in baseline “fingerprints”. Group placements done by the group analysis subsystem 1310 may be further studied to determine if there are any elements that are specific to a group's common trait or traits. Elements include but are not limited to conviction, honesty, and general feeling levels. Once common elements have been determined, insights may be made about specific groups. For example, women from 18-24 years old from rural areas have the highest conviction levels when responding to a particular question. Using group data and a respondent's behavioral baseline “fingerprint” data the group analysis subsystem 1310 may initially place a new respondent in a tentative group based on factors including but not limited to age, race, gender, socioeconomic status, political preferences, and religious affiliations. Both the group analysis subsystem 1310 and the baseline analysis subsystem 1300 may send information to the behavioral analysis subsystem 300 where predictions about respondents may be made. Predictions may be made about how groups are expected to respond to subsequent questions. For example, men between the ages of 18-30 years old are expected to vote a particular way in an upcoming election.

In summary, behavioral baselining as described in the proceeding paragraphs is a way of making physical and cognitive inferences about a respondent based on their response to generally low-cognitive burden baseline questions. Low-cognitive burden baseline questions are baseline questions which invoke little physical or emotional response from a respondent. Low cognitive burden questions may include but are not limited to questions about a respondent's name, age, or address. Responses to baseline questions provide an overall snapshot a respondent's physical and cognitive state in areas including but not limited to conviction, veracity and sentiment in a particular moment. Additionally, this data may be extrapolated to larger groups using the group analysis subsystem. Respondents may be clustered together based on a plurality of demographic data including but not limited to age, gender, socioeconomic status, political affiliation, or religious preference. Clustered groups allow for thorough group analysis because collected behavioral and psychographic data may applied to entire groups. For example, women between the ages of 18 and 24 may have the highest conviction levels regarding a question about environmental policy.

Behavior may be baselined against a single respondent's non-cognitive or low-cognitive burden behavior, against all respondent's non-cognitive or low-cognitive burden behavior, against a selected group's non-cognitive or low-cognitive burden behavior, and also as a factor of the overall divergence of all respondent's, or a selected group's) behavior on a particular question of interest versus the behavioral baseline. Observations may be made about how a behavioral baseline question differs from a non-cognitive or low-cognitive burden question. From there, behavioral and cognitive data may be used to determine how far a specific respondent's behavior differs from the expectation of responses to a specific question set based on their existing behavioral baseline.

Behavioral baselines are a snapshot of a respondent at a particular time for a particular low-cognitive question. A respondent's baseline may change over time depending their physical and cognitive condition at any moment. By injecting baseline questions at various times including throughout non-baseline questioning, behavioral baselines for each respondent can adapt to changes in the respondent's physical and cognitive condition.

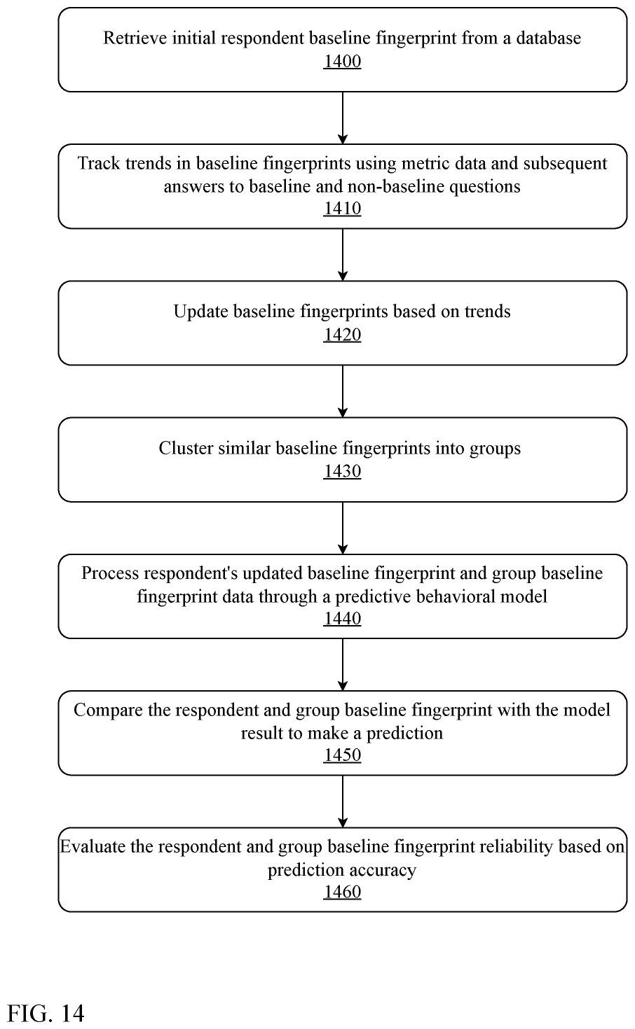

FIG. 14 is a flow diagram illustrating an exemplary method for enhanced baselining using a baseline analysis subsystem and a group analysis subsystem, according to an embodiment. In a first step 1400, retrieve initial respondent behavioral baseline “fingerprints” from a database. In step 1410, track changes in behavioral baseline “fingerprints” using metric data and subsequent answers to baseline and non-baseline questions. Metric data may include but is not limited to; mouse and finger trajectory, response and dwell time, hover or transition time, and all relevant micro-movements. In another embodiment, metric data may include the user's biometric data gathered by the user's mobile device or an electric biometric data collector connected to the user's mobile device. Biometric data may include pulse, facial color and patterns, eye tracking including dilation tracking, or breathing pattern tracking. In step 1420, update behavioral baseline “fingerprints” based on how a respondent's behavioral baseline “fingerprint” compares with the respondent's responses to non-baseline questions. In step 1430, cluster similar demographic data or behavioral baseline “fingerprints” into groups. In step 1440, process respondent's updated behavioral baseline “fingerprint” and group data through a predictive behavioral model. In step 1450, compare the respondent and group data with the model result to make a prediction about a user or groups expected future behavior. In one embodiment, predictive models may be trained using a plurality of data including but not limited to performance and sales data, behavioral data, cognitive data, and biometric data. In step 1460, evaluate the respondent and group behavioral baseline “fingerprint” reliability based on how a respondent's behavioral baseline “fingerprint” compares to the respondent's response to non-baseline questions.

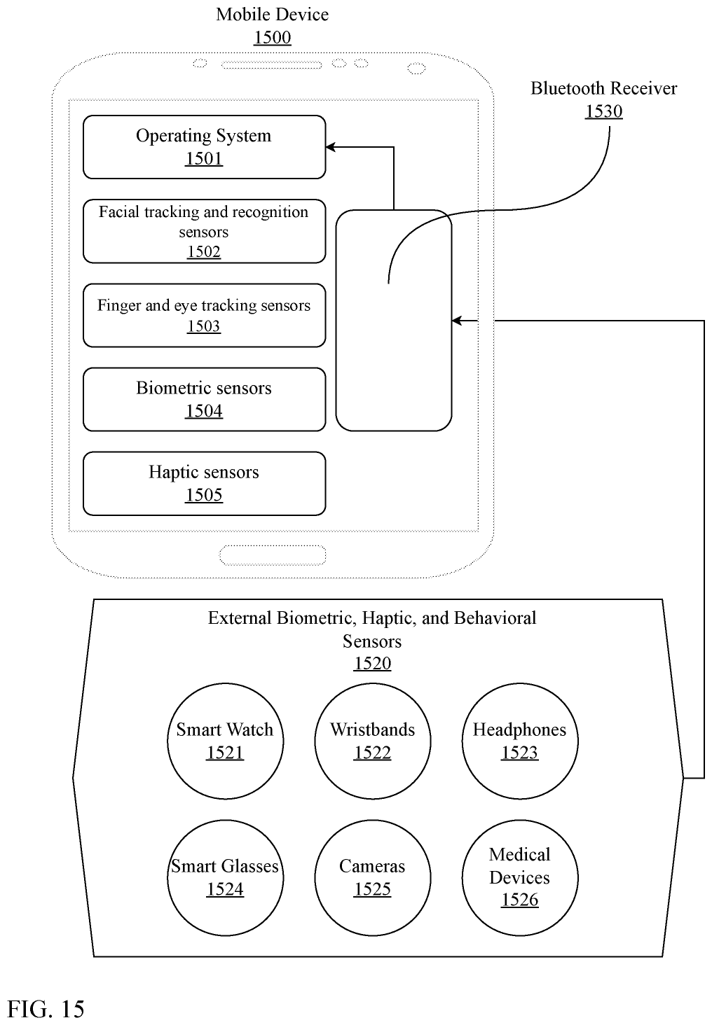

FIG. 15 is a block diagram of an exemplary aspect of a mobile device platform which collects and analyzes behavioral, haptic, and biometric data, according to one embodiment. Mobile device 1500 may be populated with a stand-alone application which administers all questions and collects respondent data during and after question submission. In another embodiment, questions may be presented to a respondent outside of a stand-alone application through any survey platform that can detect a respondent's mobile device 1500. In one embodiment, the mobile device 1500 may collect respondent data using built in sensors. Sensors may include, but are not limited to, facial tracking and recognition sensors 1502, finger and eye tracking sensors 1503, biometric scanning sensors 1504, or haptic sensors 1505. All data pertaining to connected sensors may be collected, analyzed, through an operating system 1501 installed on the mobile device 1500. This information may be shared with a platform 100 where respondent data may be incorporated into a behavioral analysis subsystem 300.

The facial tracking and recognition sensors 1501 may allow the mobile device 1500 to collect respondent data such as changes in facial color or expressions. Data about the color or shape of a respondent's face may allow a platform 100 to infer the mental and physical state of a respondent such as whether a respondent is angry or agitated which is commonly known when the face turns red, whether the respondent is bored or distracted. Data pertaining to a respondent's present physical and mental state may allow a platform 100 to create a better baseline fingerprint for a respondent and therefore make better predictions about how a respondent would behave in a given scenario. The finger and eye tracking software 1502 may allow the mobile device 1500 to collect respondent data such as where the respondent's fingers and eyes are moving, length of time it takes respondent's finger to traverse a set distance on the screen, or where the respondent's eyes are looking. This data may allow a platform 100 to make inferences such as but not limited to whether the respondent is bored because their eyes trail off, or whether they are indecisive because their finger paces back and forth over multiple possible responses. The biometric scanning software 1504 may allow the mobile device 1500 to collect respondent data such as eye dilation, heart rate, breathing patterns, or body temperature. Biometric data may allow a platform 100 to infer a respondent's mental and physical state because certain physical phenomena are related to present mental states. For example, if the respondent is sweating or has a fast heart rate, they may be nervous about making a selection. If the respondent suddenly has an increased heart rate looking at a possible answer choice, they may be angry about that possible choice. Gathering and analyzing biometric data allows a platform 100 to make more accurate predictions about how and why a respondent answers the way they do. The haptic scanning software 1505 may allow mobile device 1500 to collect respondent data such as pressure applied to a mobile device's screen, how fast the respondent moves around the mobile device 1500, or whether the respondent is moving around while answering questions.

The mobile device 1500 may receive data from external biometric, haptic, and behavioral sensors 1520 in addition to the mobile device's built in sensors. External biometric, haptic, and behavioral sensors may include all digital devices such as but not limited to, smart watches 1521, wristbands 1522, headphones 1523, smart glasses 1524, cameras 1525, or medical devices 1526.

In one embodiment, the respondent may be asked to wear a medical device 1526 by a doctor. The doctor may verbally ask the respondent a series of questions and the medical device 1526 may record a plurality of biometric, haptic, and behavioral data about the respondent. A platform 100 may then access that data through either a mobile device 1500 or another electronic device capable of maintaining a Bluetooth connection. The data may then be used to make predictions about the respondent's future behavior or how they would be expected to respond to a given question.

The mobile device 1500 may collect data from the external biometric, haptic, or behavioral sensors through a Bluetooth receiver 1530. The Bluetooth receiver 1530 receives data from a plurality of external biometric, haptic, and behavioral sensors 1520 and relays the data back to the mobile device 1500.

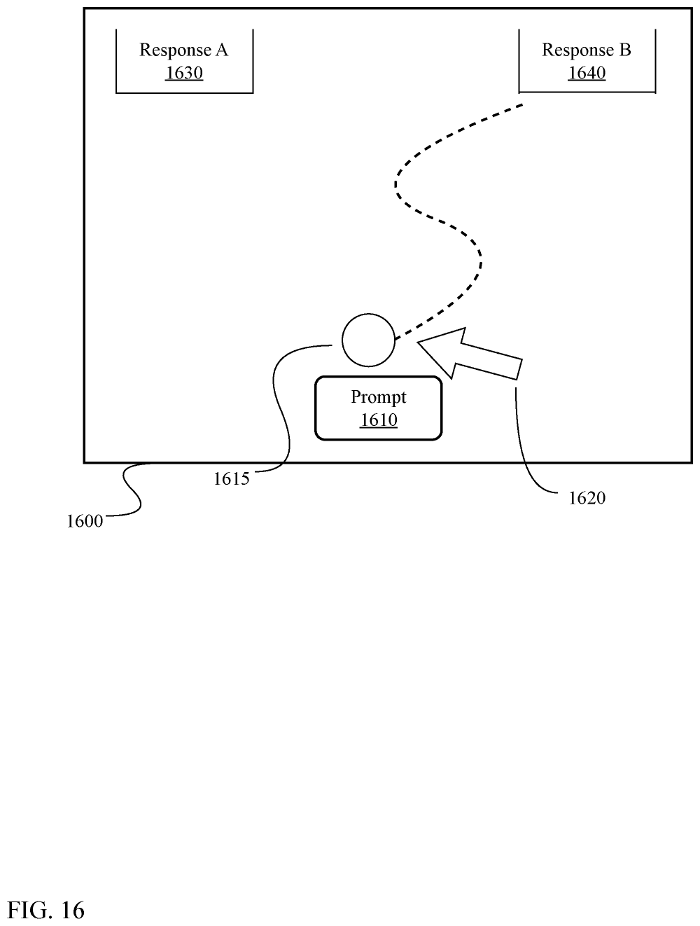

FIG. 16 is a block diagram illustrating exemplary data capture of an answer event on a respondent's device where the answer event has been gamified, according to an embodiment. The respondent's device 1600 may be a computing system (e.g., PC or laptop) or a user mobile device (e.g., smart phone or tablet) or any other device able to serve spatio-visual stimuli to a user. According to a preferred embodiment, the user uses a browser on their computing device to respond to a survey, poll, or form comprising one or more questions. An API may be present which can collect and extract various behavioral data that is generated while the user is interacting with the survey and can also transform the survey payload elements as necessary. According to the embodiment, a binary question layout is shown as comprising a prompt 1610 at the bottom center of the screen and two responses 1630, 1640 being rendered at the top left and right corners of the screen. The layout can be oriented as shown but is in no way limiting to the possible arrangement of elements that may be possible. For example, the layout may be flipped wherein the prompt 1610 is at the top of the page and the responses at the bottom corners. Another exemplary transformation may render the prompt on one side of the page and the two responses on the top and bottom corners of the other side of the page. According to the embodiment, the payload layout of the binary survey page was rendered based at least at part on a recommendation from one or more optimization models.

The prompt 1610 and responses 1630, 1640 can be text, images, multimedia, or any other content type. In an embodiment, the prompt may comprise a survey question and the responses may comprise the survey answers. The system and methods described herein can accommodate two or more responses being rendered on the page. The cursor 1620 or other pointing mechanism may be configured to start at a standardized position. In another embodiment, the respondent's finger is used as a pointing mechanism and no digital pointing mechanism is necessary. In one embodiment, the respondent answers a prompt by participating in a game where the goal is to place an object 1615 into a container where each container represents one of the possible responses. The respondent may use a curser, finger, stylus, or similar device 1620 to drag the object 1615 into a container. For example, in FIG. 16 containers are represented by response A 1630 and response B 1640. The respondent may use a curser 1620 to drag an object 1615 into the container for response B 1640. By adding objectives and goals to conducting a survey, a respondent may be more inclined to participate. Generally, gamifying a process make the process more fun and interactive, which in turn translates to more participation from respondents.

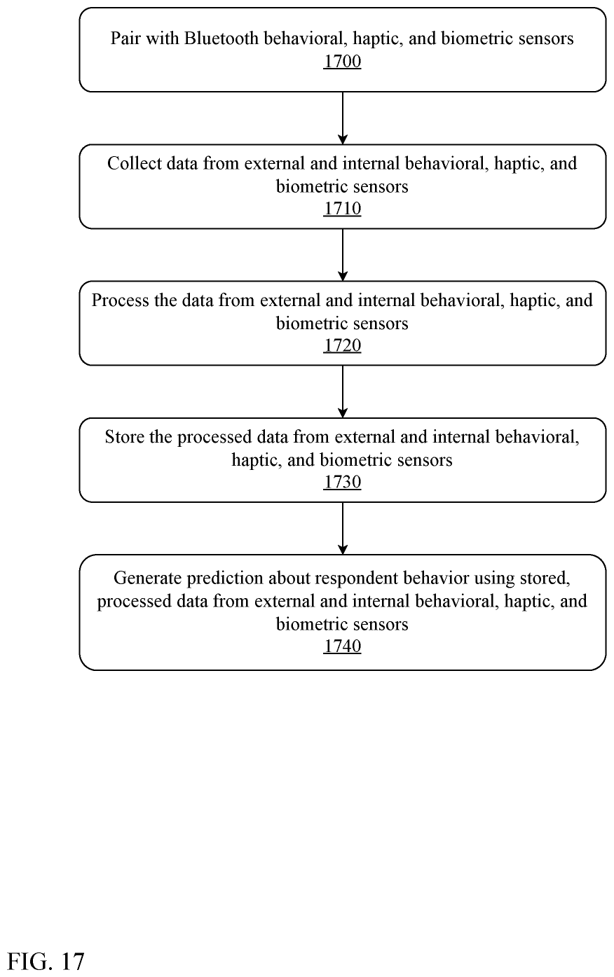

FIG. 17 is a flow diagram illustrating an exemplary method for the mobile collection and analysis of behavioral, haptic, and biometric data, according to an embodiment. In a first step 1700, pair an electronic device with Bluetooth behavioral, haptic, and biometric sensors. In step 1710, collect data from both external and internal behavioral, haptic, and biometric sensors. In step 1720, process the data from both external and internal behavioral, haptic, and biometric sensors. In step 1730, store the processed data from both external and internal behavioral, haptic, and biometric sensors. In step 1740, generate a prediction about respondent behavior using the stored, processed, data from both external and internal behavioral, haptic, and biometric sensors.

### Exemplary Computing Environment

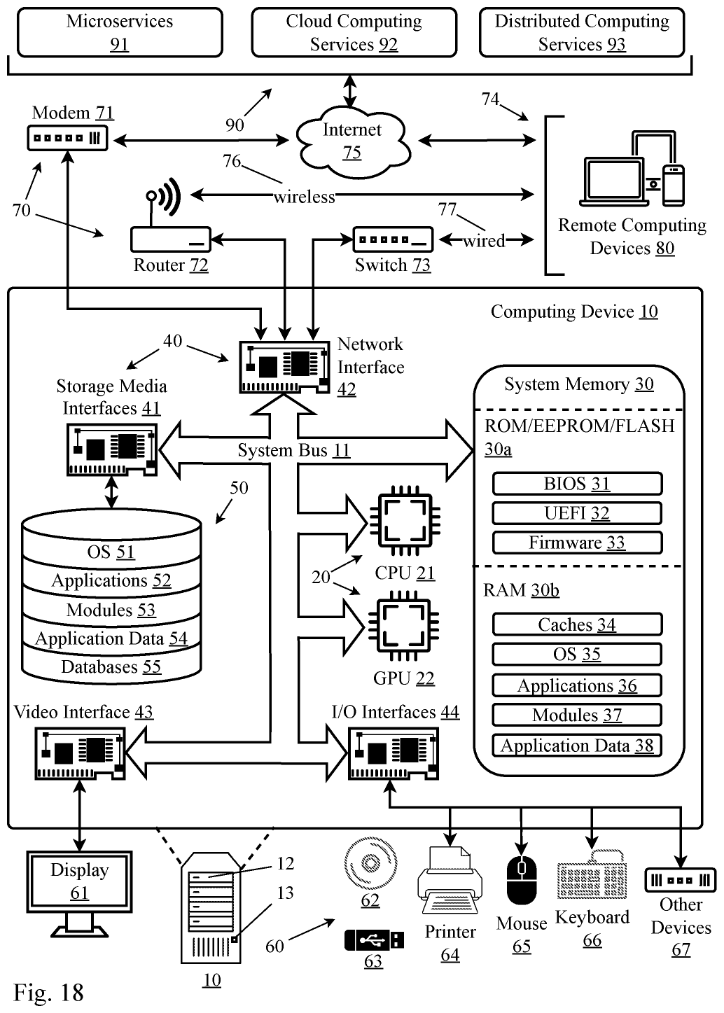

FIG. 18 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

1. A platform for enhanced behavioral analysis and classification with mobile data collection processing, and analysis, comprising:
a plurality of computing devices each comprising a processor, a memory, a network interface, and one or more data input devices or sensors;
wherein a plurality of programming instructions stored in one or more of the memories and operating on one or more processors of the plurality of computing devices causes the plurality of computing devices to:
collect a plurality of behavioral, haptic, or biometric data of a user associated with a user interface displayed on a screen, the behavioral, haptic, or biometric data comprising data captured on the one or more data input devices or sensors during periods when the user is not activating elements of the user interface;
process the plurality of behavioral, haptic, or biometric data through a behavioral model to generate a model result; and
assess a cognitive state of the user based on the model result.

2. The platform of claim 1, wherein the behavioral model generates a behavioral baseline by processing a subset of the plurality of behavioral, haptic, or biometric data associated with a plurality of baseline questions.

3. The platform of claim 2, wherein the behavioral model makes predictions about the respondent's behavioral and cognitive state based on comparisons between the plurality of behavioral, haptic, or biometric data and the behavioral baseline.

4. The platform of claim 1, wherein the plurality of behavioral, haptic, or biometric sensors are built into a mobile computing device.

5. The platform of claim 1, wherein the behavioral, haptic, or biometric data is gathered by the one or more data input devices or sensors on a mobile phone, watch, wristband, headband, sensor, or similar electronic device.

6. The platform of claim 1, wherein the behavioral, haptic, or biometric data comprises timing data, the timing data comprising response time, dwell time, hover time, and transition time.

7. The platform of claim 1, wherein the behavioral, haptic, or biometric data comprises keystroke pattern data.

8. The platform of claim 1, wherein the behavioral, haptic, or biometric data comprises one or more changes of answer.

9. A method for enhanced behavioral analysis and classification with mobile data collection processing, and analysis, comprising the steps of:
collecting a plurality of behavioral, haptic, or biometric data of a user associated with a user interface displayed on a screen, the behavioral, haptic, or biometric data comprising data captured on the one or more data input devices or sensors during periods when the user is not activating elements of the user interface;
processing the plurality of behavioral, haptic, or biometric data through a behavioral model to generate a model result, and;
assessing a cognitive state of the user based on the model result.

10. The method of claim 9, wherein the method further comprises the step of generating a behavioral baseline by processing a subset of the plurality of behavioral data using the behavioral model, wherein the plurality of behavioral data is associated with a plurality of baseline questions.

11. The method of claim 10, wherein the method further comprises the step of predicting the respondent's behavioral and cognitive state based on comparisons between the behavioral, haptic, or biometric data and the behavioral baseline.

12. The method of claim 9, wherein the one or more data input devices or sensors are built into a mobile computing device.

13. The method of claim 9, wherein the one or more data input devices or sensors are components of one or more of the following: a mobile phone, watch, wristband, or headband.

14. The method of claim 9, wherein the behavioral, haptic, or biometric data comprises timing data, the timing data comprising response time, dwell time, hover time, and transition time.

15. The method of claim 9, wherein the behavioral, haptic, or biometric data comprises keystroke pattern data.

16. The method of claim 9, wherein the behavioral, haptic, or biometric data comprises one or more changes of answer.

17. The method of claim 9, wherein the plurality of computing devices is further caused to arrange and display various payload elements of a mobile data collection form in a layout optimized for collection of the plurality of behavioral, haptic, or biometric data.

18. The method of claim 17, wherein the layout optimized for collection of the plurality of behavioral, haptic, or biometric data is a game-based user interface where the respondent completes a goal to submit a response to a question.

19. One or more non-transitory computer-storage media having computer-executable instructions embodied thereon that, when executed by one or more processors of a computing system employing a behavioral analysis platform, cause the computing system to perform the method of claim 18.

20. The platform of claim 1, wherein the plurality of computing devices is further caused to arrange and display various payload elements of a mobile data collection form in a layout optimized for collection of the plurality of behavioral, haptic, or biometric data.
